(19) United States
(12) Patent Application Publication
(10) Pub. No.: US 2026/0149529 A1
(43) Pub. Date: May 28, 2026

(54) CONTROL METHOD AND COMMUNICATION DEVICE

(71) Applicant: CANON KABUSHIKI KAISHA, Tokyo (JP)

(72) Inventor: YUKI YOSHIKAWA, Kanagawa (JP)

(21) Appl. No.: 19/394,584

(22) Filed: Nov. 19, 2025

(30) Foreign Application Priority Data
Nov. 28, 2024 (JP) 2024-206938
Sep. 29, 2025 (JP) 2025-162111

(51) Int. Cl. H04L 1/00; H04L 27/18

(52) U.S. Cl. CPC H04L 1/0003; H04L 27/18

(57) ABSTRACT

A control method for a communication device is provided. The control method includes: receiving a wireless frame for multi-user multiple input, multiple output (MU-MIMO) communication that conforms to the Institute of Electrical and Electronics Engineers (IEEE) 802.11 standards series, the wireless frame including a preamble that contains a Universal Signal field (U-SIG) as a first signal field, and a second signal field which contains information specifying a number of streams for each communication device participating in the MU-MIMO communication and information specifying a modulation and coding scheme (MCS) to be used for each stream corresponding to the number of streams, wherein the information specifying the MCS indicates that a different MCS is to be used for each of a first stream and a second stream directed at a specific communication device; and decoding the received wireless frame.

### BACKGROUND

### Field of the Technology

The present disclosure relates to a communication device that communicates data.

### Description of the Related Art

Increases in the amount of data being communicated has spurred the development of communication technologies such as wireless local area network (LAN). The Institute of Electrical and Electronics Engineers (IEEE) 802.11 standards series are known to be major communication standards for wireless LAN. The IEEE 802.11 standards series include the IEEE 802.11a/b/g/n/ac/ax/be standards and others. To improve the reliability of communication further, the IEEE 802.11bn standard is being developed as the successor to the IEEE 802.11be standard. In the IEEE 802.11WG (Working Group), which is developing the IEEE 802.11bn standard, the goals, and the scope of study of the standard will be defined in UHR SG, and the details of the specific technologies that are to be included in the standard will be defined in TGbn. Note that UHR SG is an acronym for Ultra High Reliability Study Group. Also, TGbn is an acronym for Task Group bn.

Also, as described in Japanese Patent Laid-Open No. 2020-141304, the IEEE 802.11be standard specifies the combination of a 4096-QAM modulation scheme and a 5/6 coding rate as the MCS.

### SUMMARY

According to an aspect of the present disclosure, there is provided a signaling approach for achieving both flexible signaling of the MCS and signaling of the MCS for each SS. Another aspect of the present disclosure is directed to enhancing the convenience of communication.

A control method for a communication device according to an aspect of the present disclosure includes: receiving a wireless frame for multi-user multiple input, multiple output (MU-MIMO) communication that conforms to the Institute of Electrical and Electronics Engineers (IEEE) 802.11 standards series, the wireless frame including a preamble that contains a Universal Signal field (U-SIG) as a first signal field, and a second signal field which contains information specifying a number of streams for each communication device participating in the MU-MIMO communication and information specifying a modulation and coding scheme (MCS) to be used for each stream corresponding to the number of streams, wherein the information specifying the MCS indicates that a different MCS is to be used for each of a first stream and a second stream directed at a specific communication device; and decoding the received wireless frame.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a wireless communication system.

FIG. 2 is a diagram illustrating an example of a hardware configuration of a communication device.

FIG. 3 is a diagram illustrating an example of a functional configuration of a communication device.

FIG. 4A is a flowchart illustrating an example of control executed by a communication device.

FIG. 4B is a flowchart illustrating an example of control executed by a communication device.

FIG. 5A is a schematic diagram illustrating an example of frame formats.

FIG. 5B is a schematic diagram illustrating an example of frame formats.

FIG. 6A is a schematic diagram illustrating an example of the UHR-SIG for OFDMA transmission.

FIG. 6B is a schematic diagram illustrating an example of the UHR-SIG for OFDMA transmission.

FIG. 6C is a schematic diagram illustrating an example of the UHR-SIG for OFDMA transmission.

FIG. 7A is a schematic diagram illustrating an example of the UHR-SIG for non-OFDMA transmission or the like.

FIG. 7B is a schematic diagram illustrating an example of the UHR-SIG for non-OFDMA transmission or the like.

FIG. 7C is a schematic diagram illustrating an example of the UHR-SIG for non-OFDMA transmission or the like.

FIG. 8 is an example of a sequence executed between communication devices.

FIG. 9 is a schematic diagram illustrating an example of a 5-bit Spatial Configuration field.

FIG. 10A is a schematic diagram illustrating an example of the relationship between the number of streams and the MCS in the case where there are two users.

FIG. 10B is a schematic diagram illustrating an example of the relationship between the number of streams and the MCS in the case where there are two users.

FIG. 11A is a schematic diagram illustrating an example of the relationship between the number of streams and the MCS in the case where there are three users.

FIG. 11B is a schematic diagram illustrating an example of the relationship between the number of streams and the MCS in the case where there are three users.

FIG. 11C is a schematic diagram illustrating an example of the relationship between the number of streams and the MCS in the case where there are three users.

FIG. 12A is a schematic diagram illustrating an example of the relationship between the number of streams and the corresponding MCS in the case where there are four users.

FIG. 12B is a schematic diagram illustrating an example of the relationship between the number of streams and the corresponding MCS in the case where there are four users.

FIG. 12C is a schematic diagram illustrating an example of the relationship between the number of streams and the corresponding MCS in the case where there are four users.

FIG. 12D is a schematic diagram illustrating an example of the relationship between the number of streams and the corresponding MCS in the case where there are four users.

FIG. 13A is a schematic diagram illustrating an example of the relationship between the number of streams and the corresponding MCS in the case where there are five users.

FIG. 13B is a schematic diagram illustrating an example of the relationship between the number of streams and the corresponding MCS in the case where there are five users.

FIG. 13C is a schematic diagram illustrating an example of the relationship between the number of streams and the corresponding MCS in the case where there are five users.

FIG. 14A is a schematic diagram illustrating an example of the relationship between the number of streams and the corresponding MCS in the case where there are six users.

FIG. 14B is a schematic diagram illustrating an example of the relationship between the number of streams and the corresponding MCS in the case where there are six users.

FIG. 15 is a schematic diagram illustrating an example of the relationship between the number of streams and the corresponding MCS in the case where there are seven users.

FIG. 16 is a schematic diagram illustrating an example of a 4-bit Spatial Configuration field in a modification.

FIG. 17A is a schematic diagram illustrating an example of a UEQM pattern field in a modification.

FIG. 17B is a schematic diagram illustrating an example of a UEQM pattern field in a modification.

FIG. 17C is a schematic diagram illustrating an example of a UEQM pattern field in a modification.

FIG. 18A is a flowchart illustrating an example of control executed by a communication device as a modification.

FIG. 18B is a flowchart illustrating an example of control executed by a communication device as a modification.

FIG. 19 is a schematic diagram illustrating an example of a frame format of a PPDU communicated by a communication device as a modification.

### DESCRIPTION OF THE EMBODIMENTS

The following describes embodiments in detail with reference to the attached drawings. However, the following embodiments do not limit the disclosure as recited in the claims. Although multiple features are described in the embodiments, it is not necessarily the case that all of the features are essential, and multiple embodiments may be combined in any way. Furthermore, in the attached drawings, the same or similar portions of the configuration are denoted with the same reference signs, and duplicate description is omitted.

### First Embodiment

First, certain assumptions taken into consideration will be explained. In the development of the IEEE 802.11bn standard, consideration is being given to expanding the modulation and coding scheme (MCS) combinations of a modulation scheme and a coding rate that are available for use by communication devices. The intention is to allow for communication to be carried out using a modulation scheme and a coding rate better suited to the communication channel. Also, for more efficient communication, consideration is being given to allow communication on more than one spatial stream (SS) to utilize a different MCS for each individual SS. However, no signaling approach has yet been devised to achieve both the expansion of the former and a mechanism allowing for communication using a different MCS for each individual SS of the latter. A first embodiment describes a mechanism for achieving both the expansion of the former and the allowing for communication using a different MCS for each individual SS of the latter. The following is a specific description.

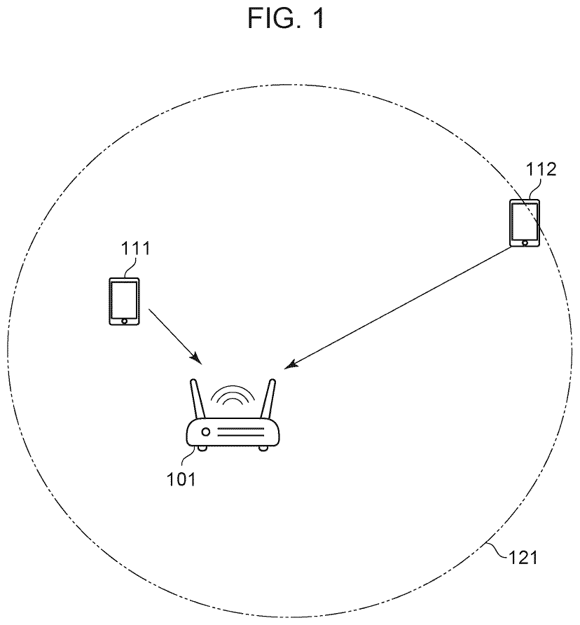

FIG. 1 illustrates an example of a configuration of a wireless communication system according to the present embodiment. The wireless communication system includes an access point (AP) 101 and stations (STAs) 111, 112, for example. The AP 101 and the STAs 111, 112 are each a communication device capable of carrying out wireless communication conforming to the IEEE 802.11 series standards. In the present embodiment, the AP 101 and the STAs 111, 112 may be referred to collectively as the communication device 100. IEEE is an abbreviation for the Institute of Electrical and Electronics Engineers. FIG. 1 illustrates a configuration in which the STAs 111, 112 join a network 121 constructed by the AP 101. The network 121 is also referred to as the Basic Service Set (BSS). FIG. 1 illustrates a configuration in one AP 101 and one STA 111 are present, but there may also be multiple APs and multiple STAs present. Also, in such a case, multiple STAs may be connected to one AP, and one STA may be connected to multiple APs.

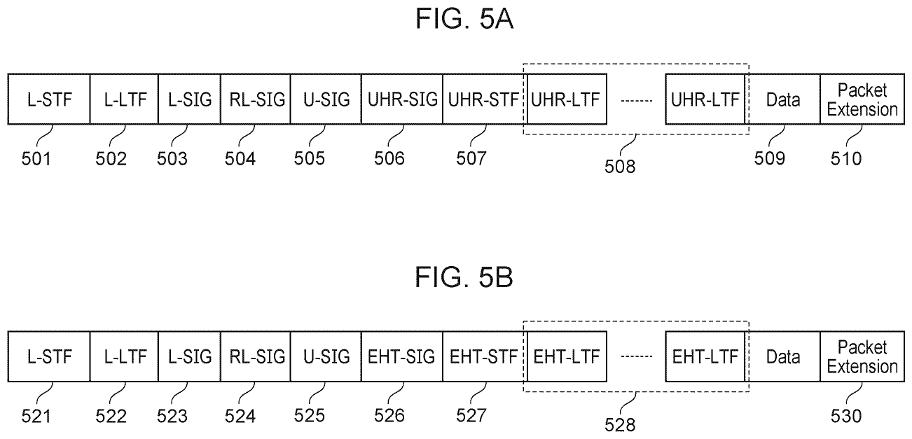

In the present embodiment, the AP 101 and the STAs 111, 112 are configured to implement a communication method conforming to the IEEE 802.11bn standard. The IEEE 802.11bn standard is the successor to the IEEE 802.11be standard that targets a maximum transmission rate of 36 gigabits per second (Gbps). The main features of the IEEE 802.11bn standard include functions for achieving highly reliable communication, low-latency communication, and increased throughput or the like when communication traffic is congested. A wireless frame used in a communication method conforming to this standard may be referred to as an Ultra High Reliability (UHR) PPDU. PPDU is an acronym for Physical layer Protocol Data Unit. Note that names such as UHR and IEEE 802.11bn may be changed to different names once the standard is finalized. It should be understood that this specification and the claims appended to this specification are applicable to communication devices using all successor standards to IEEE 802.11be. Also, the communication device 100 supports at least one legacy standard that was standardized prior to the IEEE 802.11bn standard. Legacy standards refer to the IEEE 802.11a/b/g/n/ac/ax/be standards, for example. As an example, a wireless frame used in a communication method conforming to the IEEE 802.11be standard is referred to as an Extremely High Throughput (EHT) PPDU. In a case where the communication device 100 supports both the IEEE 802.11be standard and the IEEE 802.11bn standard, the communication device 100 may support both communication using UHR PPDUs and communication using EHT PPDUs. FIGS. 5A and 5B illustrate PPDU formats. FIG. 5A illustrates an example of a UHR MU PPDU, which is classified as a UHR PPDU. FIG. 5B illustrates an example of an EHT MU PPDU, which is classified as an EHT PPDU. The details of both will be described later. The communication device 100 may also support other communication standards such as Bluetooth®, NFC, UWB, ZigBee, and MBOA. Note that UWB is an acronym for ultra-wideband, and MBOA is an acronym for MultiBand OFDM Alliance. NFC is an acronym for near-field communication. UWB includes wireless USB, wireless 1394, WiNET, and/or the like. The communication device 100 may also support a communication standard such as wired LAN. The AP 101 may be a wireless LAN router or a personal computer (PC), for example, but is not limited thereto. Other specific examples of the AP 101 include, but are not limited to, devices such as a mobile router device, a tablet, a smartphone, and digital signage. The AP 101 may also be an information processing device such as a wireless chip that can carry out wireless communication compliant with legacy standards, the IEEE 802.11bn standard, successor standards, and/or the like. The STAs 111 and 112 may each be a camera, a tablet, a smartphone, a PC, a mobile phone, a video camera, a headset, smart glasses, a head-mounted display (HMD) or other wearable device, or the like, but are not limited thereto. Other specific examples of the STAs 111 and 112 include, but are not limited to, IoT devices such as sensor nodes, and network video cameras. The STA 111 may also be an information processing device such as a wireless chip that can carry out wireless communication that supports the transmission and reception of PPDUs compliant with legacy standards, the IEEE 802.11bn standard, successor standards, and/or the like. In this case, a configuration can be adopted such that various controls are executed through hardware circuitry internal to the wireless chip. Note that a configuration can also be adopted such that various controls are executed through the cooperation of an ASIP or other processor, a memory, and hardware circuitry internal to the wireless chip. ASIP is an acronym for application-specific instruction set processor.

The communication device 100 may communicate using wireless signals in frequency bands such as the 2.4 GHz band, the 3.6 GHz band, the 5 GHz band, and the 6 GHz band, as well as frequency bands such as the 45 GHz band and the 60 GHz band, which are referred to as millimeter-wave bands. The frequency bands to be used by the communication device 100 are not limited to the above, and may also be sub-1 GHz bands, for example. The communication device 100 may also communicate using bandwidths of 20 MHz, 40 MHz, 80 MHz, 160 MHz, 320 MHz, 540 MHz, 640 MHz, 1080 MHz, and 2160 MHz. The bandwidths to be used by the communication device 100 are not limited to the above, and may also be 240 MHz and/or 4 MHz, for example. Note that in the IEEE 802.11 standards series, a frequency channel using a bandwidth of 20 MHz is specified as the basic channel in frequency bands such as the 2.4 GHz, 5 GHZ, and 6 GHz bands. Also, in the standards, multiple available channels are defined in each of the 2.4 GHz, 5 GHz, and 6 GHz frequency bands.

Some of the standards included in the IEEE 802.11 standards series specify combinations of a modulation scheme and a coding rate that are usable between communication devices. A combination of a modulation scheme and a coding rate is referred to as a modulation and coding scheme (MCS). For example, the IEEE 802.11be standard is configured such that 15 MCS combinations are available for use. Table 1 indicates a specific example of 15 MCSs specified in the IEEE 802.11be standard.

TABLE 1

| MCS index | Modulation scheme | Coding rate |
|---|---|---|
| 0 | BPSK | 1/2 |
| 1 | QPSK | 1/2 |
| 2 | QPSK | 3/4 |
| 3 | 16-QAM | 1/2 |
| 4 | 16-QAM | 3/4 |
| 5 | 64-QAM | 2/3 |
| 6 | 64-QAM | 3/4 |
| 7 | 64-QAM | 5/6 |
| 8 | 256-QAM | 3/4 |
| 9 | 256-QAM | 5/6 |
| 10 | 1024-QAM | 3/4 |
| 11 | 1024-QAM | 5/6 |
| 12 | 4096-QAM | 3/4 |
| 13 | 4096-QAM | 5/6 |
| 15 | BPSK-DCM | 1/2 |

As indicated in Table 1, each MCS, which represents a combination of one modulation scheme and one coding rate to be applied to data, has an associated index referred to as the MCS index that uniquely identifies the MCS. For example, the MCS made up of the combination of the 4096-QAM modulation scheme and the 5/6 coding rate has 13 associated therewith as the value of the MCS index. QAM is an acronym for quadrature amplitude modulation. BPSK is an abbreviation for binary phase-shift keying. QPSK is an abbreviation for quadrature phase-shift keying. DCM is an abbreviation for dual carrier modulation. In the present embodiment, the correspondence table between MCSs and MCS indices indicated in Table 1 is also referred to as the MCS table.

In a case of transmitting data to a communication device on the other side, the communication device 100 selects one MCS from among the multiple MCSs defined in a standard that the communication device 100 supports. The communication device 100 uses the selected MCS to generate a data signal to be transmitted to the communication device on the other side, and transmits a PPDU containing the data signal. To indicate the MCS that the communication device 100 used to generate the data signal to the communication device on the other side, the communication device 100 uses a prescribed area included in a preamble signal (preamble) of the PPDU. For example, in the IEEE 802.11be standard, the MCS index is stored in the prescribed area for indicating to the communication device on the receiving side the MCS that the communication device on the transmitting side used, thereby conveying the MCS to the communication device on the other side. Specifically, the communication device 100 that transmits an EHT PPDU provides a 4-bit MCS subfield in a user field constituting the EHT-SIG in the preamble of the EHT PPDU. The communication device 100 then stores the MCS index in the MCS subfield and transmits the PPDU. EHT-SIG is an abbreviation for Extremely High Throughput Signal field. Note that “0”, meaning EHT, is stored in a PHY Version Identifier subfield of the U-SIG (Universal Signal field) of the EHT PPDU. The order of field placement in the preamble is as indicated by 521 to 527 of FIG. 5B. The communication device 100 on the receiving side identifies the MCS used on the transmitting side based on the MCS index stored in the MCS subfield of the EHT-SIG field in the preamble of the received EHT PPDU. The communication device on the receiving side the acquires the data contained in a data field of the PPDU by performing demodulation processing (decoding processing) based on the identified MCS.

On the other hand, in the IEEE 802.11bn standard, consideration is being given to diversifying the MCSs that communication devices can use. For example, MCSs made up of combinations of each of the QPSK, 16QAM, and 256QAM modulation schemes and the 2/3 coding rate may be added. Also, an MCS made up of the combination of the 16QAM modulation scheme and the 5/6 coding rate may be added. These MCSs are not used in legacy standards. The addition of these MCSs will increase the types of MCSs that can be selected for communication with a STA present at a location where communication conditions are neither good nor bad within the network 121 in FIG. 1, for example. Table 2 indicates a newly defined MCS table in the present embodiment.

TABLE 2

| MCS index | Modulation scheme | Coding rate |
|---|---|---|
| 0 | BPSK | 1/2 |
| 1 | QPSK | 1/2 |
| 2 | QPSK | 2/3 |
| 3 | QPSK | 3/4 |
| 4 | 16-QAM | 1/2 |
| 5 | 16-QAM | 2/3 |
| 6 | 16-QAM | 3/4 |
| 7 | 16-QAM | 5/6 |
| 8 | 64-QAM | 2/3 |
| 9 | 64-QAM | 3/4 |
| 10 | 64-QAM | 5/6 |
| 11 | 256-QAM | 2/3 |
| 12 | 256-QAM | 3/4 |
| 13 | 256-QAM | 5/6 |
| 14 | 1024-QAM | 3/4 |
| 15 | 1024-QAM | 5/6 |
| 16 | 4096-QAM | 3/4 |
| 17 | 4096-QAM | 5/6 |
| 31 | BPSK-DCM | 1/2 |

In the present embodiment, the MCS index “2” indicates the MCS made up of the QPSK modulation scheme and the 2/3 coding rate, while the MCS index “5” indicates the MCS made up of the 16QAM modulation scheme and the 2/3 coding rate. The MCS index “7” indicates the MCS made up of the 16QAM modulation scheme and the 5/6 coding rate.

The MCS index “11” indicates the MCS made up of the 256QAM modulation scheme and the 2/3 coding rate. By newly defining MCS indices in this way, more suitable MCSs can be selectively used according to communication conditions, and retransmissions occurring under certain communication conditions can be reduced. As a result, the throughput for the BSS as a whole may be improved. In the present case where the above four MCSs have been added, it is necessary to assign new values of the MCS index to the MCSs according to a form like the one illustrated by way of example in Table 1. However, since the MCS subfield for indicating the MCS to the communication device on the other side is 4 bits in the IEEE 802.11be standard as described above, new MCS indices cannot be assigned to the added MCSs. For example, the decimal numbers that can be represented by 4 bits range from 0 to 15, but as indicated by way of example in Table 1, 14 is the only index not in use by the EHT-MCS. Consequently, there are not enough indices to assign new indices to the four MCSs to be added.

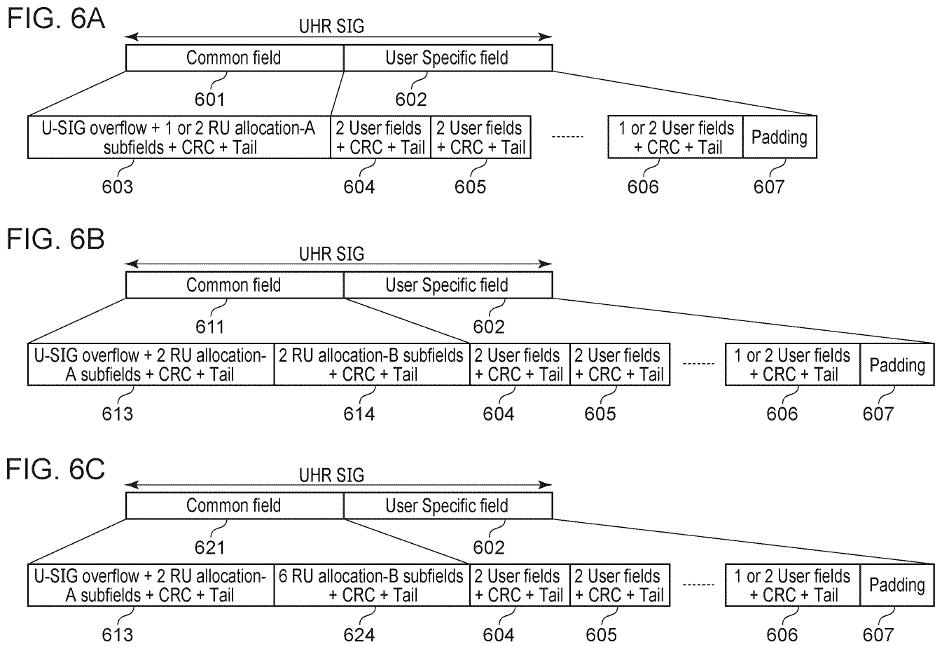

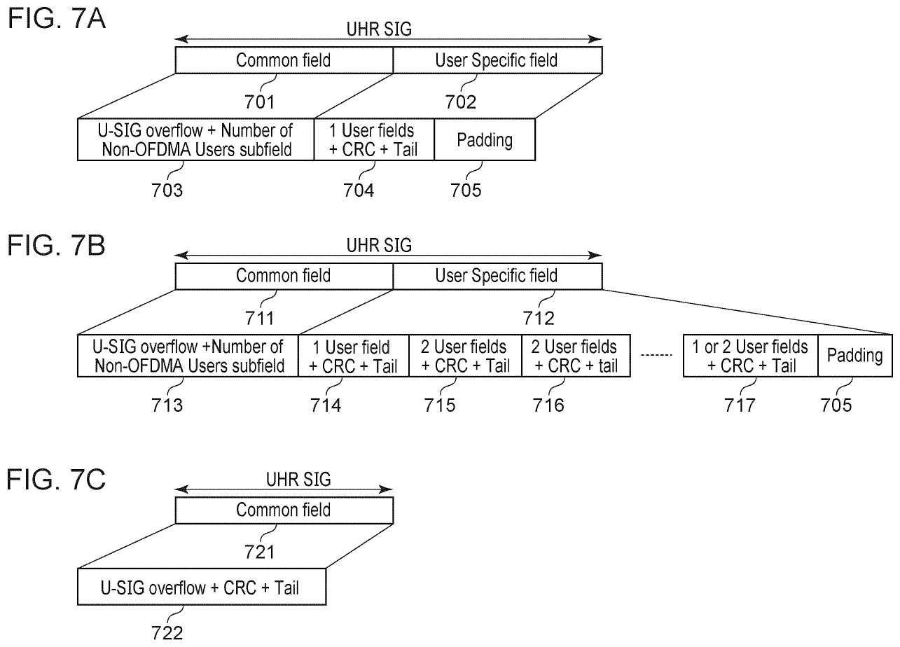

Also, in the IEEE 802.11bn standard, consideration is being given to unequal modulation (UEQM), in which a different MCS is used for each stream in which a PPDU is transmitted. In this case, the communication device on the transmitting side needs to tell the communication device on the receiving side that UEQM will be used. It is furthermore necessary to efficiently tell the communication device on the receiving side which MCS is to be applied to which stream. In the user field of the UHR-SIG described in detail later in FIGS. 6A to 7C, information identifying the communication device on the receiving side, communication parameters such as the MCS index necessary for receiving the data portion at the receiving device on the receiving side, and the like are stored. On the other hand, there is a limited number of bits that can be included in a single communication signal when transmitting the UHR-SIG. For example, one symbol could be formed from 54 bits. For efficient signaling of these 54 bits, it is desirable to store, in one symbol, user fields for two users, a 4-bit CRC field for error detector, and a 6-bit Tail field indicating the end of the symbol. This being the case, it follows that there is also a constraint in that it is desirable to keep one user field within 22 bits to reduce overhead. CRC is an acronym for cyclic redundancy check.

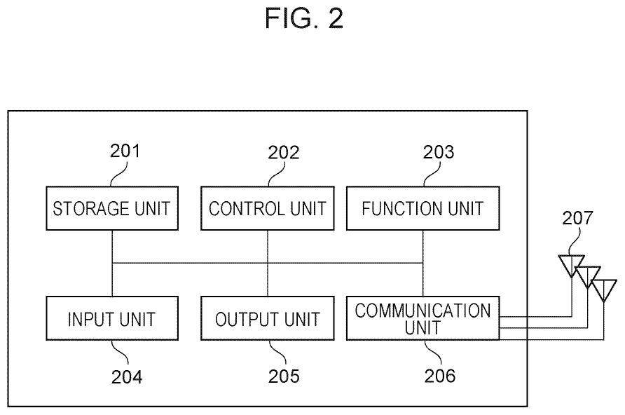

The present embodiment describes a specific UHR PPDU design defined to enable conveying of the MCS for each stream while reducing overhead, considering at least one of the above constraints. The present embodiment also describes a specific control mechanism by which UHR PPDUs of this design are exchanged between communication devices. Specifically, the communication device 100 on the transmitting side stores information that can be used to identify the MCS index for each stream in the user field of the UHR-SIG in the preamble of the UHR PPDU. By conveying this information between the communication device on the receiving side and the communication device on the transmitting side, the MCS index for each stream is signaled. Moreover, to convey the MCS for a specified stream as part of this signaling, control is applied to convey MCS index in a preamble configured to allow for the conveying of MCS indices corresponding to the new MCSs indicated by way of example in Table 2. The following uses FIG. 2 and subsequent drawings to describe a specific definition of the preamble and specific control.

### Hardware Configuration of Communication Device 100

FIG. 2 illustrates an example of the hardware configuration of the communication device 100 (AP 101, STAs 111 and 112). The communication device 100 has, as an example of the hardware configuration thereof, a storage unit 201, a control unit 202, a function unit 203, an input unit 204, an output unit 205, a communication unit 206, and antennas 207. The present embodiment illustrates an example in which there are three antennas 207, but there may also be fewer antennas. The AP 101 is assumed to have two or more antennas to allow for MU-MIMO downlink communication. Also, the STAs 111 and 112 are assumed to have one or more antennas allowing for participation in MU-MIMO downlink communication and the receiving of data in one or more spatial streams (SSs). MU-MIMO is an acronym for multi-user multiple input, multiple output.

The storage unit 201 is formed from one or both of ROM and RAM, and stores various information, such as a program for performing various operations described later and communication parameters for wireless communication. RAM is an acronym for random-access memory, and ROM is an acronym for read-only memory. Note that, besides memories such as ROM and RAM, the storage unit 201 may also use a storage medium such as a hard disk, a solid-state drive (SSD), or other non-volatile storage device.

The control unit 202 is formed from, for example, a processor such as a CPU or an MPU, an application-specific integrated circuit (ASIC), a digital signal processor (DSP), or a field-programmable gate array (FPGA). CPU is an abbreviation for central processing unit and MPU is an abbreviation for microprocessing unit. The control unit 202 controls the device overall by executing a program stored in the storage unit 201 and also causing an ASIC or other hardware circuitry to operate. Note that the control unit 202 may also control the device overall through cooperation between a program stored in the storage unit 201 and an operating system (OS).

The control unit 202 also controls the function unit 203 to execute prescribed processing such as imaging, printing, and projection. The function unit 203 is hardware with which the device executes the prescribed processing. For example, in a case where the communication device is a camera, such as a digital still camera, or a smartphone equipped with a camera, the function unit 203 is an imaging unit and performs imaging processing of images of the surroundings via a camera unit, not illustrated, that is included in the communication device. As another example, in a case where the communication device is a printer, the function unit 203 is a printing unit and performs processing for printing on a sheet such as paper based on print data obtained from the outside by wireless communication. As another example, in a case where the communication device is a projector or smart glasses, the function unit 203 is a projection unit and performs processing for projecting image data and/or video data obtained from the outside by wireless communication. In the case of smart glasses, the projection surface is the retina or the like of an end user. The data to be processed by the function unit 203 may be data stored in the storage unit 201 or data communicated with another AP or STA via the communication unit 206 described later. Furthermore, the communication device such as the AP 101 can also provide a network storage function such as network-attached storage (NAS). This function is provided to other communication devices as a web service, such as a network storage service. For example, a communication device such as a STA uses a protocol such as SMB over QUIC to connect to the network storage service provided by the AP 101 or the like. The communication device such as a STA then uploads files to the storage service and/or downloads files residing in the storage. The data communication for such uploading and/or downloading is likewise achieved by communicating UHR PPDUs between devices. SMB is an abbreviation for Server Message Block, and QUIC is an abbreviation for Quick UDP Internet Connections. Note that in a case of providing a network storage function, a configuration may be adopted such that a NAS function is provided using physical storage connected externally by USB 3.0 or USB 2.0.

The input unit 204 accepts various operations from a user. The output unit 205 provides various output to the user. In this context, the output provided by the output unit 205 includes at least one from among visual presentation on a screen, sound output by a speaker, and vibration output. Note that both the input unit 204 and the output unit 205 may also be achieved as a single module, like a touch panel.

The output unit 205 functions as a displaying unit that presents information to the user. The input unit functions as an accepting unit that accepts user operations. For example, a configuration may be adopted such that the AP 101 has one USB port into which a USB device may be inserted, and in a case of providing a NAS function using storage connected to the port, the communication protocol to use with the storage can be set by a user operation. Specifically, a user operation can be performed to set whether to use USB 2.0 or USB 3.0 as the protocol to use when communicating with the storage connected in a wired manner via the USB port. This setting is provided for the purpose of allowing the storage to be deliberately mounted in the slower USB 2.0 mode, because frequency noise emitted from devices operating in USB 3.0 mode is close to 2.4 GHz. The functions of the input unit 204 and the output unit 205 can also be implemented by another separate communication device. For example, a configuration may be adopted such that the communication device 100 itself is made to function as an HTTP server, provides settings screens to the user by providing web content corresponding to the settings screens to another communication device, and accepts operations for changing settings. HTTP is an abbreviation for Hypertext Transfer Protocol. For example, the communication device 100 such as the AP 101 provides web content corresponding to the settings screens described in the above embodiment in response to a request (HTTP request) from a web browser application provided in another communication device such as a connected STA.

The web browser application of the other communication device, such as the STA 111, that has received the web content displays a settings screen as a web screen based on the received web content. The web browser application of the other communication device then transmits, to the HTTP server, information specifying details of an operation performed via a display item on the web screen. The transmission is performed using the POST method or the like. The communication device 100 such as the AP appropriately changes operating settings stored in the storage unit 201 based on the information specifying details of the operation received from the web browser application of the STA by the POST method or the like. In a case of providing these web-based user interfaces, a configuration can also be adopted to provide the STA with web content containing a JavaScript® or other script for dynamically updating the settings screens, as necessary. In this case, it is assumed that the dynamic updating of the settings screens is performed through execution of the script as web content by a script engine of the web browser. The script engine is achieved through the execution of program code for achieving the script engine by a processor in the other communication device, such as the STA 111 or 112.

Returning to the description of FIG. 2, the communication unit 206 controls wireless communication compliant with the IEEE 802.11 series of standards and controls IP communication. In the present embodiment, the communication unit 206 can cooperate with the antennas 207 to execute communication control for the transmission and reception of UHR PPDUs, that is, wireless frames of the UHR standard, and/or PPDUs corresponding to a preceding standard. The multiple antennas 207 can transmit and receive signals in at least one frequency band from among the sub-GHz bands, the 2.4 GHz band, the 5 GHz band, the 6 GHz band, and the millimeter-wave bands, for example. As described earlier, the number of antennas is not limited to what is described, and there may be more or fewer antennas.

Note that in a case where the communication device supports the NFC standard, the Bluetooth standard, a wired communication standard, and/or the like described earlier, the communication unit 206 may be configured to control wireless communication and/or wired communication compliant with these communication standards.

### Functional Configuration of Communication Device 100

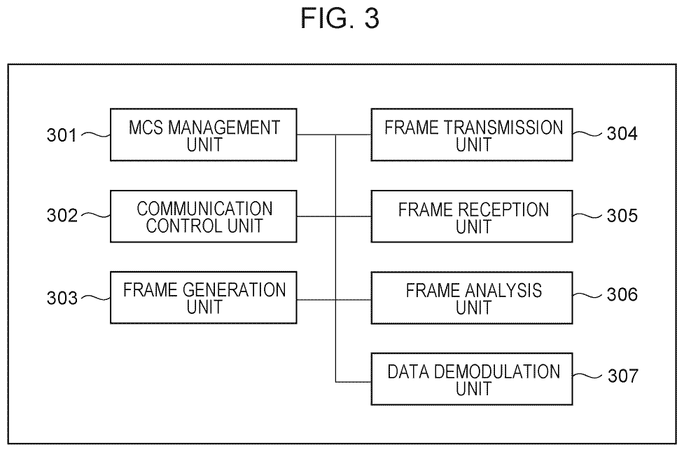

Next, FIG. 3 will be used to describe a functional configuration of the communication device 100. The communication device 100 is configured to include an MCS management unit 301, a communication control unit 302, a frame generation unit 303, a frame transmission unit 304, a frame reception unit 305, a frame analysis unit 306, and a data demodulation unit 307. The MCS management unit 301 stores the MCS table and manages the MCSs to be used for communication. For example, the MCS management unit 301 retains the MCS table that conforms to associations between MCSs defined by each standard that the communication device 100 supports and MCS indices. In a case where MCS tables are associated with standards, the MCS management unit 301 manages multiple MCS tables based on the standards that the communication device 100 supports. For example, the MCS management unit 301 retains and manages a first MCS table defined by the IEEE 802.11bn standard and a second MCS table defined by the IEEE 802.11be standard. In a case where a single standard defines multiple associations between MCSs and MCS indices, the MCS management unit 301 retains multiple MCS tables corresponding to each of the associations.

The communication control unit 302 carries out control for communicating with a counterpart, that is, another communication device.

Specifically, the communication control unit 302 cooperates with the management unit 301 to determine the type of PPDU to be used for communication and/or the MCS for generating data signals. The communication control unit 302 identifies a standard that the communication device on the other side supports, and selects a PPDU to be used for communication according to the identified standard. For example, the communication control unit 302 in the AP 101 identifies a standard that each STA such as the STA 111 and the STA 112 supports, and selects a PPDU to be used according to the data destination. As an example, in a case where the STAs 111 and 112 support a first standard (for example, the IEEE 802.11bn standard) and a second standard (for example, IEEE 802.11be), while a different STA does not support the first standard but supports the second standard, the AP 101 selects the second standard. This is to enable the transmission of data to the STAs 111, 112 and the different STA in parallel. The communication control unit 302 also cooperates with the management unit 301 to identify an MCS that the communication device on the other side can use and select the MCS to be used for communication according to the identified MCS. For example, the communication control unit 302 in the AP 101 identifies multiple MCSs that the STA 111 can use based on the standard(s) that the STA 111 supports. Next, an MCS is selected from among the identified MCSs to allow for the transmission of data at a higher data rate while suppressing retransmissions according to the conditions of the channel and/or past communication conditions with the peer device. In some cases, different MCSs are selected for streams of the same STA.

The frame generation unit 303 generates a PPDU. For example, the frame generation unit 303 generates a PPDU using the type of PPDU and the MCS selected by the communication control unit 302.

In a case where the communication control unit 302 selects a type of PPDU to be transmitted based on a standard that the communication device on the other side supports, the frame generation unit 303 constructs a PPDU that corresponds to that type of PPDU. For example, in a case where the communication control unit 302 selects transmission using an UHR MU PPDU, the frame generation unit 303 generates a PPDU by generating a preamble signal and a data signal in accordance with the configuration of the UHR MU PPDU. The frame generation unit 303 generates a data signal using the MCS selected by the communication control unit 302. The frame generation unit 303 also sets, in the preamble of the PPDU, the MCS index that corresponds to the MCS used to generate the data signal. In a case of generating a UHR MU PPDU, the frame generation unit 303 receives information from the communication control unit 302 about whether to use UEQM or EQM and which MCS to use. Table 1, Table 2, or an MCS table described later is used to identify the MCS index that corresponds to the MCS used to generate the data signal, and the identified MCS index is set in the preamble along with information on EQM or UEQM. EQM is an acronym for equal modulation. In a case of generating an EHT MU PPDU, the frame generation unit 303 uses the MCS table in Table 2 to identify the MCS index that corresponds to the MCS used to generate the data signal, and sets the identified MCS index in the preamble. The frame generation unit 303 sets, in the preamble, information that can be used to identify the MCS index to be used by the communication device on the other side. The frame transmission unit 304 cooperates with the communication unit 206, the antennas 207, and the communication control unit 302 to transmit a PPDU generated by the frame generation unit 303. The frame reception unit 305 cooperates with the communication unit 206 and the antennas 207 to receive a frame transmitted by the communication device on the other side. For example, the frame reception unit 305 receives a PPDU containing an acknowledgment of a PPDU transmitted by the frame transmission unit 304 and/or data. Also, the frame reception unit 305 of the STAs 111 and 112 receives frames such as UHR MU PPDUs transmitted by the AP 101.

The frame analysis unit 306 analyzes a PPDU received from the communication device on the other side. For example, the frame analysis unit 306 analyzes the preamble contained in the received PPDU and acquires information for acquiring data from the data signal By analyzing the preamble, the frame analysis unit 306 acquires information indicating the standard to which the PPDU conforms. The frame analysis unit 306 identifies the configuration of the PPDU based on the standard to which the PPDU conforms. The frame analysis unit 306 also identifies, based on the identified configuration of the PPDU and information on UEQM or EQM, information indicating the MCS index that corresponds to the MCS used to generate data. The frame analysis unit 306 also acquires information or the like specifying the MCS table to be used to identify the MCS from the identified MCS index. Note that in a case where standards and MCS tables are associated with one another, the frame analysis unit 306 identifies the MCS table to be used based on the information indicating the standard to which the PPDU conforms. In a case where multiple MCS tables are used situationally by a standard, the frame analysis unit 306 identifies the MCS table to be used from among multiple MCS tables defined by the standard based on some other communication parameter used for communication. The frame analysis unit 306 then uses the identified MCS table to identify, based on the MCS index contained in the PPDU, the MCS used to generate data. The data demodulation unit 307 demodulates a data signal to acquire data. For example, the data demodulation unit 307 demodulates a data signal contained in a PPDU based on an MCS identified by the frame analysis unit 306.

The present embodiment assumes that the functional configuration illustrated in FIG. 3 is achieved by having the control unit 202 execute a program stored in the storage unit 201, but is not limited thereto. A configuration may also be adopted such that some or all of the functional components illustrated in FIG. 3 are achieved by hardware circuitry such as the ASIC, FPGA, or DSP described earlier in regard to FIG. 2.

### PPDU Communication Control

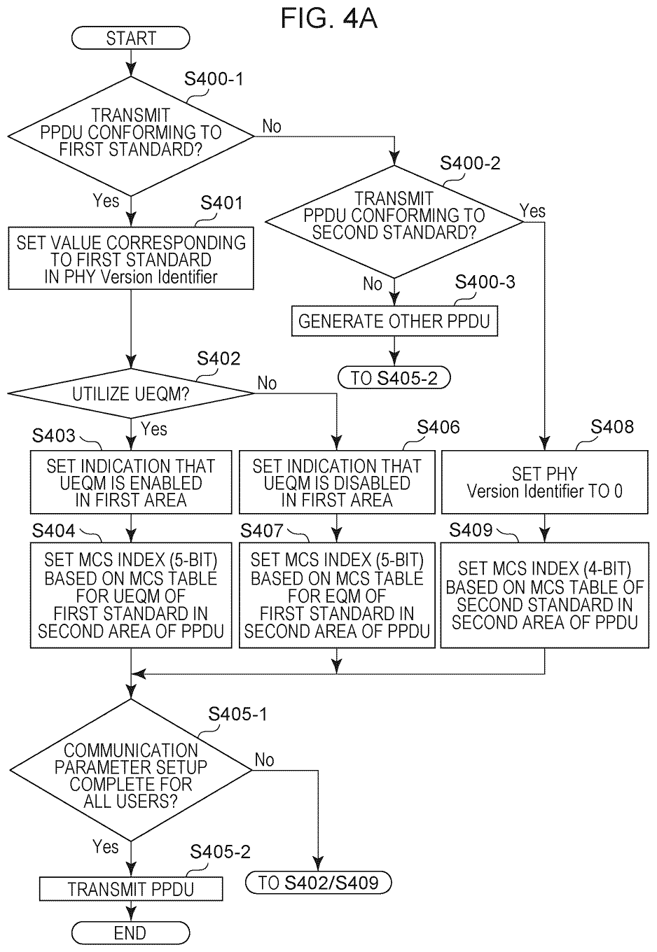

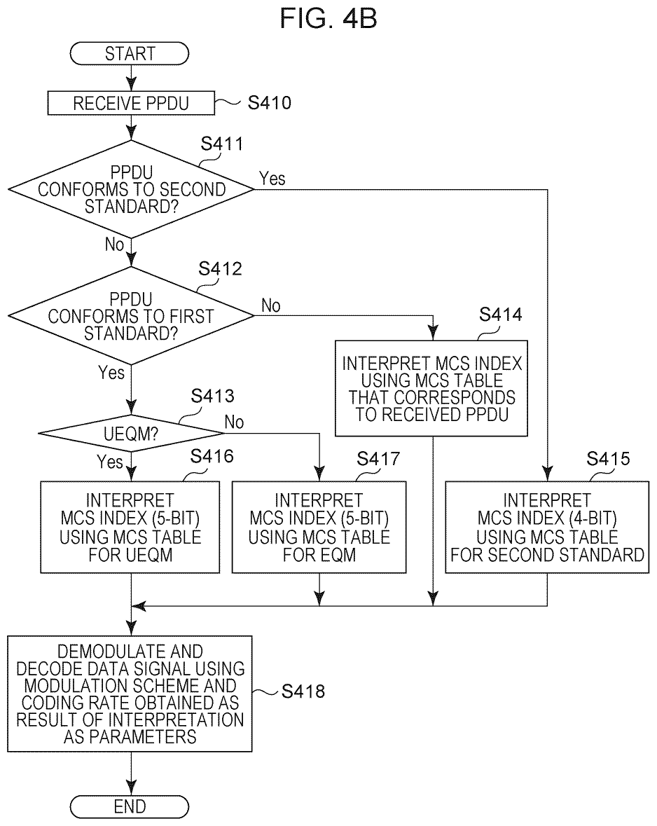

Specific control of communication will be described using FIGS. 4A and 4B. FIG. 4A is a flowchart illustrating an example of PPDU transmission control processing, and FIG. 4B is a flowchart illustrating an example of PPDU reception control processing. Each operation (step) illustrated in the flowcharts in FIGS. 4A and 4B is achieved by having the control unit 202 execute a program stored in the storage unit 201. In cases where the control provided by a functional component corresponding to the program is to be clearly indicated, the corresponding functional unit is used as the grammatical subject of the description. Also, some processes are achieved by having a functional unit achieved by the control unit 202 cooperate with hardware.

Note that since control for the transmission and reception of data should be supported by both the AP and the STA, FIGS. 4A and 4B illustrate such control without distinguishing between the control on the AP side and the control on the STA side. In other words, the AP 101 and the STAs 111, 112 that support the first standard (for example, IEEE 802.11bn) carry out the control illustrated in FIGS. 4A and 4B. Note that a different STA that does not support the first standard but supports only the second standard and earlier standards is assumed to support the transmission and reception of PPDUs conforming to standards developed prior to the second standard (such as IEEE 802.11be/ax/ac/n/a, for example). The control illustrated in FIG. 4A is initiated when the communication device 100 determining to perform multi-stream communication such as MU-MIMO or SU-MIMO in response to the input of data into a transmission buffer of the communication device 100 from a higher-layer application not illustrated in the drawings. The control is also initiated when a determination to perform MU-OFDMA communication. Note that in the present embodiment, the first standard is assumed to be IEEE 802.11bn, and the second standard is assumed to be IEEE 802.11be.

In S400-1, the communication control unit 302 cooperates with the management unit 301 to determine the type of PPDU to be used for communication. Next, base the determination result, the control unit 302 determines whether or not to transmit a PPDU conforming to the first standard. If it is determined to transmit a PPDU conforming to the first standard, the processing is advanced to S401, whereas if it is determined to transmit a PPDU conforming to the second standard, the processing is advanced to S400-2. More specifically, the communication device 100 determines the type of PPDU to be used for communication based on a standard supported by the communication device on the other side that is managed by the management unit 301. As an example, if the communication device on the other side supports the first standard but does not support the second standard, the communication device 100 determines to use a PPDU conforming to the first standard. If the communication device on the other side does not support the first standard but supports the second standard, the communication device 100 determines to use a PPDU conforming to the second standard. Note that if the communication device on the other side supports both the first standard and the second standard, the communication device 100 determines to use a PPDU conforming to the first standard. This enables communication using relatively advanced functions. Note that in a case of carrying out MU-MIMO communication or MU-OFDMA communication, there are multiple communication devices on the other side. Consequently, it is assumed that in S400-1, it is determined to use a PPDU conforming to a standard supported in common by the communication devices on the other side. For example, if communication device 1 on the other side supports IEEE 802.11bn but communication device 2 on the other side only supports legacy standards up to IEEE 802.11ac, it may be determined to use a VHT PPDU. VHT is an acronym for Very High Throughput. The communication device 100 identifies a standard that the communication device on the other side supports based on capability information received during a connection procedure when establishing a connection with the communication device on the other side. For example, the communication device 100 identifies a standard that the communication device on the other side supports by acquiring capabilities that include information that can be used to identify which standards the communication device on the other side supports. As an example, the communication device 100 identifies that the communication device on the other side supports the IEEE 802.11be standard by receiving a frame containing an EHT Capabilities element from the communication device on the other side. The communication device 100 identifies that the communication device on the other side supports the IEEE 802.11bn standard by receiving a frame containing a UHR Capabilities element from the communication device on the other side. The communication device 100 identifies that the communication device on the other side supports the IEEE 802.11ac standard by receiving a frame containing a VHT Capabilities element from the communication device on the other side. The communication device 100 identifies that the communication device on the other side supports the IEEE 802.11ax standard by receiving a frame containing an HE Capabilities element from the communication device on the other side.

Note that each of the communication device 100 and the communication device on the other side may support three or more standards included in the IEEE 802.11 standards series. In this case, the communication device 100 performs transmission processing using a PPDU that conforms to one of the standards supported by both the communication device 100 itself and the device on the other side.

Returning to the description of FIGS. 4A and 4B, in S400-2, the control unit 302 determines, based on the determination result, whether or not to transmit a PPDU conforming to the second standard. If it is determined to transmit a PPDU conforming to the second standard, the processing is advanced to S408, whereas if it is not determined to transmit a PPDU conforming to the second standard, the processing is advanced to S400-3.

In S400-3, the control unit 302 cooperates with the management unit 301 and the generation unit 303 to perform processing for generating some other PPDU. For example, if the PPDU destination includes a communication device that only supports a legacy standard such as 802.11ax/ac/n, an HE/VHT/HT PPDU or the like corresponding to the legacy standard is generated. In such a case, control is carried out to generate a PPDU which is in a format supported by the legacy standard, and in which is stored an MCS index that is usable by the legacy standard. Upon completion of the generation of an HE/VHT/HT PPDU or the like supported by the legacy standard, the control unit 302 advances the processing to S405-2.

Next, in S401, the frame generation unit 303 cooperates with the control unit 302 to set a value corresponding to the first standard in the PHY Version Identifier field of the U-SIG of the PPDU. In this field, information for identifying PHY clauses is stored. In the case where the first standard is the IEEE 802.11bn standard, the generation unit 303 sets “1”, meaning UHR. Note that in a case where the first standard is a successor standard to the IEEE 802.11bn standard, a value greater than “2” is set in PHY clauses.

Next, in S402, the control unit 302 determines whether to use UEQM or to use EQM in communication with the communication device on the other side. If it is determined to use UEQM in communication with the communication device on the other side, the processing is advanced to S403, whereas if it is determined not to use UEQM (that is, if it is determined to use EQM) in communication with the communication device on the other side, the processing is advanced to S406.

In S403, the generation unit 303 sets a value that serves as an indication that UEQM is enabled in a first area of a user field corresponding to the communication device on the other side for which the utilization of UEQM is determined in S402.

Next, in S404, the generation unit 303 sets, in a second area of the user field, an MCS index (5-bit) based on the MCS table for UEQM of the first standard.

Specific examples of MCS indices will be described later. Note that, although omitted due to space limitations, it is assumed that the generation unit 303 also appropriately sets values (for example, a value indicating the bandwidth) and the like in the other fields of the U-SIG. It is also assumed that the values and the like of the UHR-SIG and other fields constituting a second signal field for conveying user-specific information are also set appropriately. For example, a STA-ID that uniquely identifies the STA to receive is stored in B0-B11 of the user field of the second signal field.

Next, in S405-1, the generation unit 303 determines whether or not communication parameter configuration is complete for all users. If it is determined that communication parameter configuration is complete for all users, the processing is advanced to S405-2. On the other hand, if it is determined that communication parameter configuration is not complete for all users, the processing is advanced to S402 or S409 to perform parameter configuration processing for the next communication device on the other side. In other words, the preamble portion of the PPDU is generated by repeating the processing for configuring the user field a number of times equal to the number of users to which the MU PPDU is to be transmitted.

The following describes processing in the case where it is determined not to use UEQM. In S406, the generation unit 303 sets a value that serves as an indication that UEQM is disabled in the first area of the user field corresponding to the communication device on the other side. Note that this value may also be a value that serves as an indication that EQM is in use. In other words, the value set in S403 or S406 may be a value that can be used to distinguish whether EQM is in use or UEQM is in use for the modulation scheme. Next, in S407, the generation unit 303 sets, in the second area of the user field, an MCS index (5-bit) based on the MCS table for EQM according to the first standard. The MCS table for EQM to be used in S407 is the table indicated in Table 2. That is, the communication device 100 selects one MCS index from among the 19 MCS indices of 0-17 and 31, including the MCS indices 2, 5, and 11. As described earlier, 2 indicates the combination of QPSK and the 2/3 coding rate, 5 indicates the combination of 16QAM and the 2/3 coding rate, and 7 indicates the combination of 16-QAM and the 5/6 coding rate. Also, 11 indicates the combination of 256QAM and the 2/3 coding rate. These four are all newly defined combinations in the IEEE 802.11bn standard.

The following describes processing for the case where it is determined to transmit a PPDU conforming to the second standard. In S408, the generation unit 303 cooperates with the control unit 302 to set a value corresponding to the second standard in the PHY Version Identifier field of the U-SIG of the PPDU. In this field, information for identifying PHY clauses is stored. In the case where the first standard is the IEEE 802.11be standard, the generation unit 303 sets “0”, meaning EHT. Next, in S409, the generation unit 303 sets, in a third area of the user field, an MCS index (4-bit) based on the MCS table of the second standard. The third area is, for example, the 4-bit area of the MCS subfield made up of B11-B14 in the user field, which is made up of 22 bits. The MCS table of the second standard in S409 is the table indicated in Table 1, for example. That is, the communication device 100 selects one MCS index from among the 15 MCS indices of 0-13 and 15.

Lastly, in S405-2, the transmission unit 304 cooperates with the generation unit 303, the communication unit 206, and the antennas 207 to carry out control such that a wireless signal corresponding to the PPDU is transmitted from the antennas 207. The wireless signal corresponding to the PPDU transmitted by this control includes the preamble generated by the generation unit 303 and a data field. In the data field, the communication device 100 stores and transmits data modulated/coded using the modulation scheme and coding rate corresponding to the MCS index specified in the second area or the third area of the preamble of the PPDU. Also, the communication device 100 controls the multiple antennas 207 based on the spatial stream configuration specified for each communication device in the preamble, and transmits independent data streams corresponding to the spatial streams to the outside. Upon completion of the transmission of data, the communication device 100 ends the series of MU PPDU transmission processing operations.

The following uses FIG. 4B to describe PPDU reception control. This processing flow is initiated based on, for example, the communication device 100 accepting input of a legacy preamble of an IEEE 802.11 PPDU via the antennas 207 of the device.

In S410, the frame reception unit 305 cooperates with the analysis unit 306, the antennas 207, and the communication unit 206 to carry out PPDU reception control and analysis control. A signal received by the reception unit 305 is analyzed by the analysis unit 306. The analysis unit 306 analyzes information in the preamble to identify the standard to which the PPDU conforms. In S411, the analysis unit 306 uses a result of the analysis as a basis for determining whether the received PPDU conforms to the second standard. If it is determined that the received PPDU conforms to the second standard, the processing is advanced to S415, whereas if it is not determined that the received PPDU conforms to the second standard, the processing is advanced to S412. In S412, the analysis unit 306 uses the result of the analysis as a basis for determining whether the received PPDU conforms to the first standard. If it is determined that the received PPDU conforms to the first standard, the processing is advanced to S413, whereas if it is not determined that the received PPDU conforms to the first standard, the processing is advanced to S414.

First, processing will be described for the case of receiving a PPDU of a standards series different from the first and second standards. In S414, the analysis unit 306 uses an MCS table that corresponds to the received PPDU to interpret the MCS index addressed to itself that is stored in the MCS field/MCS subfield in the PPDU. Upon completion of the interpretation, the communication device 100 advances the processing to S418. Next, processing will be described for the case of receiving a PPDU of the second standard. In S415, the analysis unit 306 identifies the user field corresponding to its own STA-ID from among one or more user fields included in the PPDU of the second standard, and acquires the MCS index made up of 4 bits from the third area of the identified user field. Next, the analysis unit 306 references an MCS table for the second standard and interprets the acquired MCS index. As an example, the following describes a case in which “2” is specified as the MCS index in the third area of the user field that matches the STA-ID of the receiving device. The analysis unit 306 acquires the information corresponding to “2” in Table 1, and thus ascertains that the data portion of the PPDU is modulated and coded by the combination of the QPSK modulation scheme and the 3/4 coding rate.

Lastly, processing will be described for the case of receiving a PPDU that conforms to the first standard. In S413, the analysis unit 306 identifies the user field corresponding to its own STA-ID, and acquires the value in the first area of the user field corresponding to its own STA-ID. If the value in the first area indicates that UEQM is enabled, the processing is advanced to S416. On the other hand, if the value in the first area indicates that UEQM is not enabled (that is, indicates that EQM is to be used), the processing is advanced to S417.

Next, in S416, the analysis unit 306 acquires the MCS index made up of 5 bits from the second area of the user field corresponding to its own STA-ID. Next, the analysis unit 306 references an MCS table for UEQM of the second standard and interprets the acquired MCS index. Details will be described later. On the other hand, in S417, the analysis unit 306 acquires the MCS index made up of 5 bits from the second area of the user field corresponding to its own STA-ID. Next, the analysis unit 306 references an MCS table (for example, Table 2) for EQM of the second standard and interprets the acquired MCS index. For example, if “2” is specified as the MCS index addressed to the receiving device, it is ascertained that one or more data streams addressed to the receiving device are modulated and coded by the combination of the QPSK modulation scheme and the 2/3 coding rate (see Table 2). Lastly, in S418, the data demodulation unit 307 performs processing to demodulate and decode the data signal using multiple parameters, including the modulation scheme/coding rate obtained as a result of the interpretation of the preamble by the analysis unit 306, as parameters for demodulation and decoding. Upon completion of the processing for demodulation and decoding, the series of reception processing operations is ended.

Note that, although omitted due to space limitations, if the data obtained by demodulation and decoding is information for controlling IEEE 802.11 communication (a management frame and/or a control frame conforming to IEEE 802.11), the information is processed by the communication control unit 302.

In other words, if the information obtained by decoding is a MAC frame such as a management frame or a control frame, the communication control unit 302 carries out suitable control based on the information. MAC is an abbreviation for Medium Access Control. If the data obtained by demodulation and decoding is an IEEE 802.11 data frame, the data frame is transferred to a communication unit in a higher layer (for example, a protocol stack in the IP layer), not illustrated, and interpretation processing is performed by the higher layer.

### Example of Operating Sequence

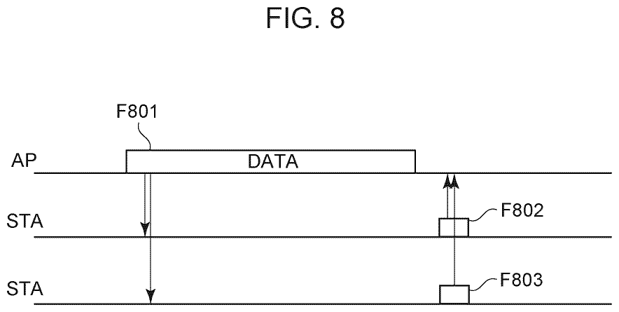

Next, FIG. 8 will be used to describe an example of the communication control described using FIGS. 4A and 4B. As an example, the AP 101 transmits a data frame in MU-MIMO format, that is, a PPDU that conforms to the first standard, to multiple STAs including the STA 111 (F801). The multiple recipient STAs, including the STA 111, each analyze the data frame in MU-MIMO format, that is, the PPDU that conforms to the first standard, identify communication parameters addressed to itself, and obtain data addressed to itself. Each of the STAs that have received data then replies with an acknowledgment of receipt (F802, F803). The acknowledgment of receipt is an Ack, a Block Ack, a Multiple Block Ack, or the like.

### Example of PPDU Format

FIGS. 5A to 7C and Tables 3 to 11 will be used to describe an example of a PPDU communicated by the processing described using FIGS. 4A and 4B or the sequence described using FIG. 8. FIG. 5A illustrates an example of a UHR MU PPDU transmitted and/or received by the communication device 100. FIG. 5B illustrates an EHT MU PPDU transmitted and/or received by the communication device 100. MU PPDU is an acronym for Multi-User PPDU. The UHR MU PPDU is used in downlink communication proceeding from the AP 101 to a STA such as the STA 111. The UHR MU PPDU is also used in a case where a STA such as the STA 111 carries out uplink communication by single-user communication (SU) or the like. Furthermore, the UHR MU PPDU may also be used in a case where a STA carries out uplink MU-MIMO communication with multiple APs participating in Multi-AP coordination.

FIG. 5A will be used to describe the UHR MU PPDU. The UHR MU PPDU is configured to include L-STF 501, L-LTF 502, L-SIG 503, RL-SIG 504, U-SIG 505, UHR-SIG 506, UHR-STF 507, and UHR-LTF 508. There may also be more than one UHR-LTF 508 included in the UHR MU PPDU. Note that L-STF 501 to UHR-LTF 508 are referred to as the preamble. STF is an acronym for short training field. LTF is an acronym for long training field. SIG is an acronym for signal field. U-SIG is an acronym for Universal Signal field. L-STF is also referred to as the non-HT short training field. L-LTF is also referred to as the non-HT long training field. L-SIG is also referred to as the non-HT signal field. In addition, the UHR MU PPDU includes Data 509 and Packet Extension 510. The field 510 is also referred to as PE. Data 509 is also referred to as the data portion or the like out of convenience. Note that some types of PPDUs may not include Data 509. The fields from L-STF 501 to L-SIG 503 are for ensuring backward compatibility with legacy standards (IEEE 802.11a/b/g/n/ac/ax/be and the like). In other words, a communication device supporting a legacy standard recognizes L-STF 501 to L-SIG 503 and detects the presence of an IEEE 802.11 frame. L-STF 501 is used for wireless frame detection, automatic gain control, timing detection, and the like. Automatic gain control is also referred to as AGC. L-LTF 502 is used for high-precision frequency synchronization, timing synchronization, acquisition of propagation channel information, and the like. Propagation channel information is also referred to as channel state information (CSI). L-SIG 503 is used to provide notification of control information indicating the PPDU length (packet length) and the like. RL-SIG 504 has content similar to L-SIG 503. For example, the presence of RL-SIG 504 in the PPDU indicates that the PPDU is of the IEEE 802.11ax standard or a subsequently released standard. UHR-STF 507 is a short training field used for automatic gain control in MIMO communication. UHR-LTF 508 is a long training field used for MIMO channel estimation in the communication device on the receiving side. Data 509 is a data signal. Data 509 is an area containing data to be communicated, and may contain one or more MPDUs, for example. MPDU is an acronym for Medium Access Control (MAC) Protocol Data Unit. The data signal corresponding to Data 509 is generated using an MCS selected by the communication device 100 on the side that transmits the PPDU. Packet Extension 510 is used to provide additional reception processing time to the communication device 100 on the receiving side. U-SIG 505 and/or UHR-SIG 506 contain additional information for interpretation of the UHR MU PPDU by the communication device 100 on the receiving side. Details will be described later. In the case of the UHR MU PPDU, the U-SIG is an example of a first signal field and the UHR-SIG is an example of a second signal field. In the case of the EHT MU PPDU, the U-SIG is an example of a third signal field and the EHT-SIG is an example of a fourth signal field.

The EHT MU PPDU illustrated in FIG. 5B has a configuration similar to the UHR MU PPDU. The fields 521 to 524 are similar to the fields 501 to 504 of the UHR MU PPDU. U-SIG 525 is a field of the same size as U-SIG 505. U-SIG 505 and U-SIG 525, as the names suggest, may have a common field design portion that does not depend on the standard and a standard-specific portion that depends on the standard. Details will be described later in the description of Table 3. EHT-SIG 526 includes, as information for interpretation of the EHT MU PPDU by the communication device 100 on the receiving side, a Common field for all users and a user field for each user, the number of user fields being equal to the number of users involved in simultaneous communication. Although a detailed description is omitted, in the EHT MU PPDU, as described earlier, the MCS is indicated using the 4-bit MCS subfield made up of B11-B14 of the user field in the EHT-SIG. On the other hand, the UHR MU PPDU differs from the EHT MU PPDU in that the MCS is indicated using 5 bits in the user field of the UHR-SIG. EHT-STF 527 is a short training field for the IEEE 802.11be standard. EHT-LTF 528 is a long training field for the IEEE 802.11be standard. The data signal corresponding to Data is generated using an MCS selected by the communication device 100 on the side that transmits the PPDU. Packet Extension 530 is used to provide additional reception processing time to the communication device 100 on the receiving side.

The following uses Table 3 to describe the configuration of the U-SIG included in a PPDU such as the UHR MU PPDU and the EHT MU PPDU.

TABLE 3
U-SIG (UHR MU PPDU/EHT MU PPDU)

| | Bit | | No. of | |
|---|---|---|---|---|
| | position | Subfield | bits | Description |
| U-SIG-1 | B0-B2 | PHY Version | 3 | PHY version. 0: EHT. 1: UHR. 2-7: Reserved. |
| | | Identifier | | |
| | B3-B5 | Bandwidth | 3 | Bandwidth. 0: 20 MHz. 1: 40 MHz. 2: 80 MHz. |
| | | | | 3: 160 MHz. 4: 320 MHz-1. 5: 320 MHz-2. 6-7: |
| | | | | Reserved. |
| | B6 | UL/DL | 1 | Indicates whether PPDU is UL or DL |
| | B7-B12 | BSS Color | 6 | 6 bits for identifying BSS |
| | B13-B19 | TXOP | 7 | Length of TXOP |
| | B20-B24 | Disregard | 5 | All bits are 1 |
| | B25 | Validate | 1 | Reserved area |
| U-SIG-2 | B0-B1 | PPDU Type | 2 | Indicates PPDU type |
| | | And | | [When UL/DL is 1] |
| | | Compression | | 0: DL OFDMA. 1: SU or sounding NDP. 2: non- |
| | | Mode | | OFDMA DL MU MIMO. 3: ELR described later. |
| | | | | [When UL/DL is 0] |
| | | | | 0: TB PPDU. 1: SU or sounding NDP. 2: non- |
| | | | | OFDMA UL MU MIMO. 3: ELR described later. |
| | B2 | Validate | 1 | Reserved area |
| | B3-B7 | Punctured | 5 | Indicates PPDU puncture pattern |
| | | Channel | | |
| | | Information | | |
| | B8 | Validate | 1 | Reserved area |
| | B9-B10 | EHT- | 2 | Indicates MCS of EHT-SIG or UHR-SIG. 0: |
| | | SIG/UHR-SIG | | EHT-MCS 0 or UHR-MCS 0. 1: EHT-MCS 1 or |
| | | MCS | | UHR-MCS 1. 2: EHT-MCS 3 or UHR-MCS 4. |
| | | | | 3: EHT-MCS 15 or UHR-MCS 31 |
| | B11-B15 | Number Of | 5 | Number of EHT/SIG/UHR-SIG symbols |
| | | EHT/UHR-SIG | | |
| | | Symbols | | |
| | B16-B19 | CRC | 4 | CRC value of bits 0-41 of U-SIG field |
| | B20-B25 | Tail | 6 | Value indicates end when decoding |

As indicated by way of example in Table 3, U-SIG 505/525 is formed from two parts, namely U-SIG-1 and U-SIG-2. U-SIG 505/525 may have a common portion that does not depend on the standard and a standard-specific portion that depends on the standard. For example, the five subfields of PHY Version Identifier, Bandwidth, UL/DL, BSS Color, and TXOP included in U-SIG-1 may be the common portion. The PHY Version Identifier field made up of 3 bits at the beginning of the U-SIG indicates information specifying a PHY layer configuration as a PHY version. As an example, a value of 0 is set in the case of a PPDU that conforms to the IEEE 802.11bn standard, as typified by the EHT MU PPDU or the like illustrated by way of example in FIG. 5B. Also, 1 is set in the case of a PPDU that conforms to the IEEE 802.11bn standard, as typified by the UHR MU PPDU or the like illustrated by way of example in FIG. 5A. The EHT-SIG/UHR-SIG MCS field in U-SIG-2 stores a value specifying the MCS used to generate UHR-SIG 506/EHT-SIG 526 that comes after U-SIG 505/525. In the present embodiment, the serialized values of this field are given different meanings to enable utilization of the 16QAM modulation scheme and the 1/2 coding rate even in the case of a UHR PPDU. In other words, the values are redesigned so that when “2” is stored in the EHT-SIG/UHR-SIG MCS field of the UHR PPDU, the meaning is UHR-MCS4.

Similarly, the meaning of the preamble is redesigned so that when “3” is stored in the EHT-SIG/UHR-SIG MCS field of the UHR PPDU, the meaning is UHR-MCS31. That is, the values stored in the field are configured such that the corresponding MCS index numbers are partially different compared to the case of the EHT PPDU.

Note that in the present embodiment, the other fields of U-SIG 505 are designed such that the respective fields of the U-SIG-1 symbols and the U-SIG-2 symbols are consistent with U-SIG 525 of the EHT MU PPDU. However, as described earlier, the bit areas that correspond to standard-specific portions that depend on the standard naturally may adopt different field configurations. Fields in bit areas that correspond to standard-specific portions are also referred to as version-dependent fields.

Next, UHR-SIG 506 will be described using FIGS. 6A to 6C. FIGS. 6A to 6C illustrate an example of the configuration of UHR-SIG 506 in the UHR MU PPDU to be used in a case where the communication device 100 performs OFDMA transmission. OFDMA is an acronym for orthogonal frequency-division multiple access. FIG. 6A illustrates an example of the configuration of UHR-SIG 506 in the case where a UHR MU PPDU with a bandwidth of 20 MHz, 40 MHz, or 80 MHz is used. FIG. 6B illustrates an example of the configuration of UHR-SIG 506 in the case where a UHR MU PPDU with a bandwidth of 160 MHz is used. FIG. 6C illustrates an example of the configuration of UHR-SIG 506 in the case where a UHR MU PPDU with a bandwidth of 320 MHz is used. FIGS. 7A to 7C illustrate an example of the configuration of UHR-SIG 506 in the UHR MU PPDU to be used in a case where the communication device 100 performs transmission other than OFDMA transmission. FIG. 7A illustrates an example of the configuration of UHR-SIG 506 in the UHR MU PPDU to be used in a case where the communication device 100 performs single-user (SU) transmission with one communication device. FIG. 7B illustrates an example of the configuration of UHR-SIG 506 in the UHR MU PPDU to be used in a case where the communication device 100 performs multi-user transmission without using OFDMA. The format in FIG. 7B is used in a case where the communication device carries out communication according to a MU-MIMO transmission scheme. FIG. 7C illustrates an example of the configuration of UHR-SIG 506 in the UHR MU PPDU to be used in a case where the communication device 100 transmits a Sounding NDP.

### Details of Format in OFDMA Transmission Scheme

The UHR-SIG illustrated in FIG. 6A is configured to include a Common field 601 and a User Specific field 602. The Common field 601 contains information to be used in common by one or more communication devices 100 on the receiving side that are to receive the PPDU. The Common field 601 may contain a U-SIG overflow subfield, one or two RU allocation-A subfields, and CRC and Tail subfields. First, details of the Common field 601 will be described using Table 4.

TABLE 4
Common field for OFMDA transmission, UHR

| Bit | | No. of | No. of | |
|---|---|---|---|---|
| position | Subfield | subfields | bits | Description |
| B0-B3 | Spatial Reuse | 1 | 4 | Indicates whether Spatial Reuse |
| | | | | is permitted, and if so, specifies |
| | | | | limit on permissible TX power |
| B4-B5 | GI + LTF Size | 1 | 2 | Size of GI and EHT/UHR-LTF |
| B6-B8 | Number Of | 1 | 3 | Number of EHT/UHR-LTF |
| | EHT/UHR-LTF | | | symbols |
| | Symbols | | | |
| B9 | LDPC Extra | 1 | 1 | Presence or absence of LDPC |
| | Symbol Segment | | | extra symbol segment |
| B10-B11 | Pre-FEC Padding | 1 | 2 | Pre-FEC padding |
| | Factor | | | |
| B12 | PE Disambiguity | 1 | 1 | PE disambiguity |
| B13-B16 | Disregard | 1 | 4 | Reserved area. All bits set to 1. |
| B17-B16 + | RU Allocation-A | N | 9 | Number N of RU Allocation-A |
| 9N | | | | subfields in EHT/UHR-SIG |
| | | | | content channel. |
| | | | | If U-SIG bandwidth is 0 or 1, |
| | | | | N = 1. If U-SIG bandwidth is 2-5, N = 2. |
| | | | | Allocation indicates RUs, MRUs. |
| B17 + 9N- | CRC | 1 | 4 | CRC value of bits 0-16 + 9N |
| B20 + 9N | | | | |
| B21 + 9N- | Tail | 1 | 6 | Value indicates end when decoding |
| B26 + 9N | | | | |

The following subfields are used if U-SIG bandwidth
is set to 160 MHz, 320 MHz-1, or 320 MHz-2.

| | | | | |
|---|---|---|---|---|
| B27 + 9N- | RU Allocation-B | M | 9 | Number M of RU Allocation-B |
| B26 + 9N + 9M | | | | subfields in EHT/UHR-SIG |
| | | | | content channel. |
| | | | | Indicates value only if U-SIG |
| | | | | bandwidth is 160 MHz, 320 |
| | | | | MHz-1, or 320 MHz-2. |
| | | | | If U-SIG bandwidth is 3, M = 2. If |
| | | | | U-SIG bandwidth is 4 or 5, M = 6. |
| | | | | Allocation indicates RUs, MRUs. |
| B27 + 9N + 9M- | CRC | 0 or 1 | 4 | Used only for 160 MHz, 320 MHz-1, or |
| B30 + 9N + 9M | | | | 320 MHz-2. CRC value of bits 27 + 9N- |
| | | | | 26 + 9N + 9M |
| B31 + 9N + 9M- | Tail | 0 or 1 | 6 | Used only for 160 MHz, 320 MHz-1, or |
| B36 + 9N + 9M | | | | 320 MHz-2. Value indicates end when |
| | | | | decoding |

Note that field 601 in the example of the configuration of the UHR-SIG illustrated in FIG. 6A corresponds to the portion of B0-B26+9N in Table 4. For example, the portion of B0-B16 in Table 4 corresponds to the U-SIG overflow subfield in area 603.

Also, area 603 in the example of the configuration of UHR-SIG 506 illustrated in FIG. 6A corresponds to the portion from B27+9N to B36+9N+9M in Table 4. The portion from B27+9N to B36+9N+9M in Table 4 is included in the example of the configuration of UHR-SIG 506 illustrated in FIG. 6B described later.

The User Specific field 602 contains information to be indicated individually to each of the one or more communication devices 100 on the receiving side that are to receive the PPDU. Note that in the following, “user” may denote the communication device 100 used by that user. For example, the area allocated to each user stores information to be conveyed to the communication device 100 used by each user. For example, the first user field in area 604 may be allocated to the STA 111 described in FIG. 1, and the second user field may be allocated to the STA 112. Area 604 and area 605 may each be formed from two user fields, a CRC subfield, and a Tail subfield. Area 606 may be formed from one or two user fields, a CRC subfield, and a Tail subfield. Also, a Padding field 607 may be included at the end, as needed. The field configuration of areas 604 to 606 will be described using Table 5.

TABLE 5
User encoding block

| Bit | | No. of | |
|---|---|---|---|
| position | Subfield | bits | Description |
| B0-B22N − 1 | User | 22 | User field described later. N = 1 if last user or only |
| | field | | user; N = 2 otherwise. |
| | | | I.e., 1 block includes user fields for up to 2 users. |
| B22N-B22N + 3 | CRC | 4 | CRC value of bits 0-21 |
| B22N + 4- | Tail | 6 | Value indicates end when decoding |
| B22N + 9 | | | |

Areas 604 to 606 contain approximately half of the user fields that are equal in number to the number of users involved in simultaneous transmission. To reduce the overhead of preamble transmission, the UHR-SIG is conveyed in two content channels at intervals of 20 MHz. Specifically, user information is conveyed by being split into two content channels, namely UHR-SIG content channel 1 and UHR-SIG content channel 2. Consequently, UHR-SIG content channel 1, which is transmitted on odd-numbered 20 MHz subbands, stores a number of user fields equal to “(number-of-users/2)+number-of-users mod 2”.

UHR-SIG content channel 2, which is transmitted on even-numbered 20 MHz subbands, stores a number of user fields equal to “(number-of-users/2)”.

Tables 6 and 7 will be used to describe an example of the information contained in the user field described using Table 5. Table 6 illustrates an example of information included in a user field in area 604 and areas 605 and 606 in a case where MU-MIMO is not used in the transmission of the UHR MU PPDU. Table 7 illustrates an example of information included in a user field in area 604 and areas 605 and 606 in a case where MU-MIMO is used in the transmission of the UHR MU PPDU.

TABLE 6
User field for non-MU-MIMO transmission, UHR

| Bit | | No. of | |
|---|---|---|---|
| position | Subfield | bits | Description |
| B0-B10 | STA-ID | 11 | STA-ID of TXVECTOR parameter |
| B11-B15 | MCS | 5 | Value of MCS for UHR |
| B15-B18 | NSS | 3 | Value is number of spatial streams minus 1 |
| | | | If STA-ID is 2046, may be set to any value. |
| B19 | EQM/UEQM | 1 | 0: EQM. 1: UEQM. |
| B20 | Beamformed | 1 | 1 if applying beamforming steering matrix to non-MU- |
| | | | MIMO waveform; 0 otherwise. |
| | | | If STA-ID is 2046, may be set to any value. |
| B21 | Coding | 1 | 0: BCC. 1: LDPC. |
| | | | If STA-ID is 2046, may be set to any value. |

TABLE 7
User field for MU-MIMO transmission, UHR

| Bit | | No. of | |
|---|---|---|---|
| position | Subfield | bits | Description |
| B0-B10 | STA-ID | 11 | STA-ID of TXVECTOR parameter |
| B11-B15 | MCS | 5 | Value of MCS for UHR |
| B16 | EQM/UEQM | 1 | 0: EQM. 1: UEQM. |
| B17-B20 | Spatial | 4 | Allocation of number of spatial streams to |
| | Configuration | | each user for MU-MIMO |
| B21 | Coding | 1 | 0: BCC. 1: LDPC. |
| | | | Always set to 1 if using UEQM. |
| | | | If STA-ID is 2046, may be set to any value. |

A 5-bit MCS subfield is provided in both the user field indicated in Table 6 and the user field indicated in Table 7. The user field indicated in Table 7 includes a 4-bit Spatial Configuration subfield from B17 to B20. This differs from the user field for MU-MIMO transmission the EHT PPDU in that the Spatial Configuration subfield, which was 6 bits in the EHT PPDU, is reduced by 2 bits. The Spatial Configuration subfield stores information indicating the allocation of a number of streams for each user. In the case of both Table 6 and Table 7, a 1-bit EQM/UEQM field is provided in the user field. As described earlier, the communication device 100 uses this EQM/UEQM field to signal to each communication device on the other side whether the same MCS or different MCSs are used to generate the data signal. For example, in a case where a communication device such as the AP 101/STA 111 uses a different MCS for each stream with respect to the communication device on the other side, 1 is stored in the EQM/UEQM field. In a case where a communication device such as the AP 101/STA 111 uses the same MCS for multiple streams, 0 is stored in the EQM/UEQM field. Also, in a case of transmitting data in a single stream to the communication device 100 on the other side, 0 is stored in the EQM/UEQM field. The MCS table to be used, as indicated by an MCS field described later, is different depending on whether the value of the EQM/UEQM field is 1 or 0. For example, the MCS table indicated in Table 2 is used if the value of the EQM/UEQM field is 0. On the other hand, the MCS table indicated in Table 8 is used if the value of the EQM/UEQM field is 1.

TABLE 8

| MCS index | ss1 | ss2 |
|---|---|---|
| 0 | MCS1 | MCS0 |
| 1 | MCS2 | MCS1 |
| 2 | MCS3 | MCS2 |
| 3 | MCS4 | MCS3 |
| 4 | MCS5 | MCS4 |
| 5 | MCS6 | MCS5 |
| 6 | MCS7 | MCS6 |
| 7 | MCS9 | MCS8 |
| 8 | MCS10 | MCS9 |
| 9 | MCS11 | MCS10 |
| 10 | MCS12 | MCS11 |
| 11 | MCS13 | MCS12 |
| 12 | MCS14 | MCS13 |
| 13 | MCS15 | MCS14 |
| 14 | MCS16 | MCS15 |
| 15 | MCS17 | MCS16 |
| 16 | MCS2 | MCS0 |
| 17 | MCS3 | MCS1 |
| 18 | MCS4 | MCS2 |
| 19 | MCS5 | MCS3 |
| 20 | MCS6 | MCS4 |
| 21 | MCS7 | MCS5 |
| 22 | MCS8 | MCS6 |
| 23 | MCS9 | MCS7 |
| 24 | MCS10 | MCS8 |
| 25 | MCS11 | MCS9 |
| 26 | MCS12 | MCS10 |
| 27 | MCS13 | MCS11 |
| 28 | MCS14 | MCS12 |
| 29 | MCS15 | MCS13 |
| 30 | MCS16 | MCS14 |
| 31 | MCS17 | MCS15 |

In other words, the value of the 1-bit EQM/UEQM field in the user field is used as the above first area for indicating information for specifying whether UEQM is used or EQM is used.

The MCS index indicated in Table 8 is configured such that a single MCS index indicates the respective MCSs for two streams. Note that the MCS index indicated in Table 8 may be referred to as the UEQM MCS index or the like. In the present embodiment, signaling overhead is reduced by imposing constraints on combinations, rather than representing all possible combinations. Specifically, combination patterns are limited to a first pattern and a second pattern. In the first pattern, the MCS that is one step lower in rate than the MCS of the main stream is set as the MCS of the sub stream. In the second pattern, the MCS that is two steps lower in rate than the MCS of the main stream is set as the MCS of the sub stream. This constraint is imposed based on the understanding that, although it is naturally useful to slightly adjust modulation schemes between the transmitting device and the receiving device in accordance with some difference in the communication quality for each stream, it is difficult to envision situations where the communication quality differs significantly for each stream. In other words, it can be said that such a reduction in signaling overhead is implemented based on the understanding that constraining the MCS patterns to combinations with small rate differences does not pose any operational issues. Note that the present embodiment assumes that the MCS subfield is made up of 5 bits. The values that can be stored in the MCS subfield thus range from 0 to 31, making it possible to express an index of 32 values. In this case, enumerating all patterns with an MCS index difference of 1 between the streams and an MCS index difference of 2 between the streams results in a total of 33 possibilities, which will not fit in a 5-bit field. Consequently, in this example, some combinations are additionally excluded from the UEQM MCS index to define a UEQM MCS index that will fit in 5 bits. Herein, the case of excluding the combination of UHR-MCS8 and UHR-MCS7 is given as an example. Combinations of rates that are classified as low- to medium-speed rates assumed to have little difference in required communication quality are excluded. This increases the likelihood of usefully implementing combinations that can be expressed using UEQM. Note that the above idea regarding exclusion is an example, and various modifications are conceivable. For example, combinations of MCS indices that are both low, such as the combination MCS2 for stream 1 and MCS0 for stream 2, may also be excluded. This is based on the understanding that UEQM is originally intended to improve communication quality by differentiating MCSs on a per-stream basis for high MCSs, and is not expected to be highly effective for combinations with low MCS indices. In this way, a configuration may be adopted to exclude combinations of MCS indices that are both low and expected to have little effect.

The communication device 100 may use the MCS subfield storing the UEQM UHR MCS to indicate the MCS index of the MCS used to generate the data signal to each communication device on the other side. For example, the AP 101 may use the UHR MU PPDU to transmit, by OFDMA, downstream data respectively addressed to each of the STA 111 and the STA 112. In this case, the AP 101 may indicate to the STA 111 the MCS index corresponding to the MCS used to generate the data signal addressed to the STA 111 by setting the corresponding MCS index in the MCS subfield included in the user field allocated to the STA 111. Similarly, the AP 101 may indicate to the STA 112 the MCS index corresponding to the MCS used to generate the data signal addressed to the STA 112 by setting the corresponding MCS index in the MCS subfield included in the user field allocated to the STA 112. Note that in this case, the STA-ID of the STA 111 is stored in the STA-ID subfield of the user field for the STA 111, and the STA-ID indicating the STA 112 is set in the STA-ID subfield of the user field for the STA 112.

Each of the STA 111 and the STA 112 detects the STA-ID subfield in which its own STA-ID is set, and thereby identifies communication parameters, including the MCS index, set in the MCS subfield allocated to itself. The data portion is then considered to have been transmitted using the identified MCS, and the data portion is demodulated accordingly.

For example, if the UEQM UHR-MCS stored in the MCS subfield has a value of 5, this means that stream 1 is modulated and encoded using MCS6 as the MCS index, and stream 2 is modulated and encoded using MCS5 as the MCS index. Note that the example indicated in Table 8 is for the case where there are two streams. In the case where there are three streams, stream 1 and stream 2 use the MCS index value for SS1 in Table 8, and stream 8 uses the MCS index value for SS2 in Table 8. Similarly, in the case where there are four streams, stream 1, stream 2, and stream 3 may use the MCS index value for SS1 in Table 8, and stream 4 may use the MCS index value for SS2 in Table 8. In cases where there are five or more streams, a number of streams equal to the maximum number of streams minus 1 may use the MCS index value for SS1 in Table 8, and the remaining stream may use the MCS index value for SS2.

Returning the description of FIGS. 6A to 6C, the field configuration of the UHR MU PPDU of 160 MHz or higher will be described briefly. FIG. 6B illustrates an example of the configuration of UHR-SIG 506 in the case where a UHR MU PPDU with a bandwidth of 160 MHz is used. The configuration in this example differs from the configuration of UHR-SIG 601 illustrated in FIG. 6A in that two RU Allocation-B subfields, a CRC subfield, and a Tail subfield are included as area 614 of the Common field 611. Area 613 has a configuration similar to area 603, but always includes two RU Allocation-A subfields. Area 614 is the field corresponding to the portion from B27+9N to B36+9N+9M in Table 4. That is, the UHR-SIG illustrated in FIG. 6B includes more information for indicating the resource mapping of Resource Units (RUs) to support OFDMA transmission using the UHR MU PPDU with a bandwidth of 160 MHz. FIG. 6C is an example of the configuration of the UHR-SIG included in a UHR MU PPDU with a bandwidth of 320 MHz. The configuration in this example differs from the configuration of the UHR-SIG illustrated in FIG. 6A or FIG. 6B in that six RU Allocation-B subfields are included as area 624 of the Common field 621. That is, UHR-SIG 506 illustrated in FIG. 6C includes information on 8×20 MHz, equal to 160 MHz, to support OFDMA transmission using the UHR MU PPDU with a bandwidth of 320 MHz. This information is likewise indicated as different information in U-SIG content channels 1 and 2 described earlier. That is, a resource allocation for 160 MHz is indicated in channel 1, and a resource allocation for a different 160 MHz is indicated in channel 2. The communication device on the transmitting side transmits these two resource allocations to thereby indicate a resource allocation for 320 MHz to the communication device on the receiving side. Note that the configuration of the User Specific field in FIG. 6B and FIG. 6C is similar to FIG. 6A, and therefore a description is omitted.

### Example of Configuration of UHR-SIG for SU Transmission

The following uses FIG. 7A to describe an example of the configuration of the UHR-SIG in a case of performing SU communication. FIG. 7A illustrates an example of the configuration of UHR-SIG 506 in the UHR MU PPDU to be used in a case where the communication device 100 performs single-user (SU) transmission. The UHR-SIG illustrated in FIG. 7A is configured to include a Common field 701 and a User Specific field 702. The common field 701 and the User Specific field 702 are formed using one OFDMA symbol indicated in Table 9.

That is, one OFDMA symbol includes areas 703 to 705. The Common field 701 includes a U-SIG overflow subfield and a Number of Non-OFDMA Users subfield. Table 9 will be used to describe an example of the information included in the Common field 701 and the User Specific field 702.

TABLE 9
UHR-SIG/EHT-SIG for SU transmission, EHT/UHR

| Bit | | No. of | |
|---|---|---|---|
| position | Subfield | bits | Description |
| B0-B16 | Common field for an | 20 | Common field for EHT/UHR SU |
| | EHT/SU transmission | | transmission or non-OFDMA transmission |
| B17-B19 | Number Of non-OFDMA | 3 | Total number of non-OFDMA users. |
| | Users | | Value + 1 indicates number of users. For SU |
| | | | communication, value of 0 is stored. |
| B20-B41 | User field | 22 | User field for non-MU-MIMO |
| B42-B45 | CRC | 4 | CRC value of bits 0-41 |
| B46-B51 | Tail | 6 | Value indicates end when decoding |

The configuration of B0-B16 in Table 9 is similar to the configuration of B0-B16 in Table 4. In the SU transmission indicated in Table 9, the fields from B17 onward are different from the case of OFDMA transmission. Specifically, the difference is the inclusion of the Number of Non-OFDMA Users subfield from B17 to B19. The Number of Non-OFDMA Users subfield stores the number of Non-OFDMA users. In the case of SU transmission illustrated by way of example in FIG. 7A, 0 is set. The User field from B20 to B41 stores information that is similar to the user field for OFDMA transmission described using Table 5 and Table 6. B42-B45 is the CRC subfield, which stores cyclic redundancy check bits. The 6 bits from B46 to B51 is the Tail subfield, which stores 0. Accordingly, even in the case of performing single-user (SU) transmission, a 5-bit MCS subfield will be included in the user field included in the UHR MU PPDU. Also, a 1-bit EQM/UEQM subfield will be included in the user field. Setting appropriate values in these MCS and EQM/UEQM subfields makes it possible to convey EQM, or UEQM in the case of SU MIMO, to the receiving-side device appropriately. That is, in the case of communication in one stream, a configuration may be adopted to provide an indication of EQM and to store one of the MCS indices indicated in Table 2 in the MCS subfield. Likewise, in the case of communication in two or more streams, a configuration may be adopted to indicate EQM and to store a common MCS for all streams in the MCS subfield. Alternatively, in the case of communication in two or more streams for which a different MCS is to be used for each stream, a configuration may be adopted such that the communication device 100 on the transmitting side indicates UEQM and indicates one of the MCS indices indicated in Table 8 in the MCS subfield. The MCS for each stream may be conveyed to the counterpart. In this case, the communication device 100 on the receiving side identifies the user field in which is specified the STA-ID corresponding to itself. The MCS corresponding to each stream may then be identified based on the MCS index stored in the MCS subfield of the identified user field, and the table indicated in Table 8.

### Example of Configuration of UHR-SIG for Case of Performing Non-OFDMA Multi-User Transmission

The following describes an example of the configuration of the UHR-SIG illustrated in FIG. 7B. FIG. 7B illustrates an example of the configuration of the UHR-SIG in the UHR MU PPDU to be used in a case where the communication device 100 performs multi-user transmission without using OFDMA. In other words, FIG. 7B illustrates an example of the configuration of the UHR-SIG for the case of performing MU-MIMO communication. The UHR-SIG is configured to include a Common field 711 and a User Specific field 712. An example of the information included in the Common field 711 is indicated in Table 10. The Common field 711 is configured similarly to the Common field 701 in FIG. 7A. That is, the Common field 711 differs from the Common field 701 in Table 9 in that the Number of Non-OFDMA Users (B17-B19) subfield in Table 9 is set to a value of 1 or more. For example, in a case where the AP 101 uses MU-MIMO to transmit a plurality of data addressed to two communication devices, namely the STA 111 and the STA 112, the Number of Non-OFDMA Users subfield is set to a value of 1.

TABLE 10
Common field for non-OFMDA transmission, EHT/UHR

| Bit | | No. of | |
|---|---|---|---|
| position | Subfield | bits | Description |
| B0-B3 | Spatial Reuse | 4 | Indicates whether Spatial Reuse is permitted, |
| | | | and if so, specifies limit on permissible TX |
| | | | power |
| B4-B5 | GI + LTF Size | 2 | Size of GI and EHT/UHR-LTF |
| B6-B8 | Number Of | 3 | Number of EHT/UHR-LTF symbols |
| | EHT/UHR-LTF | | |
| | Symbols | | |
| B9 | LDPC Extra Symbol | 1 | Presence or absence of LDPC extra symbol |
| | Segment | | segment |
| B10-B11 | Pre-FEC Padding | 2 | Pre-FEC padding |
| | Factor | | |
| B12 | PE Disambiguity | 1 | PE disambiguity |
| B13-B16 | Disregard | 4 | Reserved area. All bits set to 1. |
| B17-B19 | Number Of non- | 3 | Total number of non-OFDMA users. |
| | OFDMA Users | | Value + 1 indicates number of users. |
| | | | (E.g., 1 is set for simultaneous transmission to 2 |
| | | | users, 2 is set for simultaneous transmission to 3 |
| | | | users.) |

Returning to the description of FIG. 7B, the User Specific field 712 is configured to include at least area 714 and area 715. Area 714 is configured similar to area 704 in FIG. 7A, and includes one user field, a CRC, and a Tail. Area 715 may include two user fields, a CRC, and a Tail. The User Specific field 712 may further include area 716 and/or area 717, which store one or two user fields. That is, the User Specific field 712 may include user fields respectively corresponding to the communication devices 100 set as the recipients of the multi-user transmission. In other words, the fields in the User Specific field 712 include the subfields described using Table 7. Note that area 713 and area 714 may also be configured to be conveyed in one OFDMA symbol.

Accordingly, in a case where the communication device 100 performs multi-user transmission without using OFDMA, a 1-bit EQM/UEQM subfield in the user field is likewise used as the first area of the PPDU for indicating UEQM described above. Also, a 5-bit MCS subfield in the user field of the PPDU is used as the second area of the PPDU for indicating the MCS index described above.

### Example of Configuration of UHR-SIG for Sounding NDP Communication

The following describes an example of the configuration of UHR-SIG 506 illustrated in FIG. 7C. FIG. 7C illustrates an example of the configuration of UHR-SIG 506 in the UHR MU PPDU to be used in a case where the communication device 100 transmits a Sounding NDP. A Sounding NDP is a null data packet used to perform channel estimation between communication devices. UHR-SIG 506 illustrated in FIG. 7C is made up of a Common field 721. That is, the example of the configuration of the UHR-SIG illustrated in FIG. 7C lacks a User Specific field, and thus differs from UHR-SIG 506 of the other examples. The Common field 721 is made up of area 722. An example of the information included in area 722 is indicated in Table 11.

TABLE 11
Common field for EHT/UHR sounding NDP

| Bit | | No. of | |
|---|---|---|---|
| position | Subfield | bits | Description |
| B0-B3 | Spatial Reuse | 4 | Indicates whether Spatial Reuse is permitted, |
| | | | and if so, specifies limit on permissible TX |
| | | | power |
| B4-B5 | GI + LTF Size | 2 | Size of GI and EHT/UHR-LTF |
| B6-B8 | Number Of | 3 | Number of EHT/UHR-LTF symbols |
| | EHT/UHR-LTF | | |
| | Symbols | | |
| B9-B12 | NSS | 4 | Number of spatial streams to use for EHT/UHR |
| | | | sounding NDP |
| B13 | Beamformed | 1 | 1 if applying beamforming steering matrix to |
| | | | EHT/UHR modulated field |
| B14-B15 | Disregard | 2 | Reserved area. All bits set to 1. |
| B16-B19 | CRC | 4 | CRC value of bits 0-16 + 9N |
| B20-B25 | Tail | 6 | Value indicates end when decoding |

The Sounding NDP, being a null data frame, does not contain a data signal.

That is, the UHR MU PPDU to be used for Sounding NDP transmission differs from the other PPDUs in FIGS. 6A to 7C by not including a subfield corresponding to the EQM/UEQM subfield described above or a 5-bit MCS subfield.

In this way, in a case where the communication device 100 uses the UHR MU PPDU, the EQM/UEQM subfield of the user field may be used to indicate the MCS index for each stream indicated in the MCS field to the communication device on the other side. With this arrangement, the communication device on the other side may determine the MCS index to use for data demodulation from the MCS field. Also, the communication device 100 may use the 5-bit MCS subfield in UHR-SIG 506 to indicate the MCS index corresponding to the MCS used to generate the data signal included in the PPDU to the communication device on the other side. The above mechanisms allow for appropriate indication that different MCSs are being used for multiple streams (for example, a first stream and a second stream) in a case of communicating by allocating the multiple streams to a specific communication device.

Note that the examples of the configuration of the PPDU included in the description above and the description below and the examples of the configuration of the subfields indicated in the tables are merely examples. That is, the PPDU may also include other fields and/or subfields, and may also not include some fields and/or subfields. Also, each field and/or subfield may also be used to indicate other information. Moreover, the name of each field and/or subfield is an example. For example, the EQM/UEQM subfield may store any information that substantially makes it possible to distinguish whether EQM is used or UEQM is used, and the name of the field may be changed freely. For example, the UEQM subfield may also be used, or a name such as Modulation Type subfield may be used.

### Second Embodiment

The first embodiment gives an example of the case of providing a 1-bit subfield to indicate whether EQM is used or UEQM is used. The second embodiment describes a modification in which the MCS subfield is expanded to 6 bits, and the 6-bit MCS subfield is used to indicate a mixed MCS index that contains a mix of values corresponding to both EQM schemes and UEQM schemes. Table 12 will be used to describe an example of the user field in this case.

TABLE 12
User field for MU-MIMO transmission, UHR (modification)

| Bit | | No. of | |
|---|---|---|---|
| position | Subfield | bits | Description |
| B0-B10 | STA-ID | 11 | STA-ID of TXVECTOR parameter |
| B11-B16 | MCS | 6 | Value of MCS for UHR |
| B17-B20 | Spatial | 4 | Allocation of number of spatial streams to each |
| | Configuration | | user for MU-MIMO |
| B21 | Coding | 1 | 0: BCC. 1: LDPC. |
| | | | If STA-ID is 2046, may be set to any value. |

The user field indicated in Table 12 is a modification of the user field indicated in Table 7. The field configuration in Table 12 differs from the example indicated in Table 7 in that the MCS field is 6 bits and the EQM/UEQM field is not present. In the case of the present embodiment, first, the communication device 100 that is to transmit data determines the MCS for each stream. The communication device then stores an MCS index indicating the mixed MCS set corresponding to the determined MCSs in the MCS field, thereby conveying the MCS for each stream to the device on the receiving side. Hereinafter, for simplicity, the 6-bit MCS index indicated in the second embodiment is also referred to as the mixed MCS index. The mixed MCS index will be described using Table 13.

TABLE 13

| MCS Index | ss1 | ss2 |
|---|---|---|
| 0 | MCS0 | MCS0 |
| 1 | MCS1 | MCS1 |
| 2 | MCS2 | MCS2 |
| 3 | MCS3 | MCS3 |
| 4 | MCS4 | MCS4 |
| 5 | MCS5 | MCS5 |
| 6 | MCS6 | MCS6 |
| 7 | MCS7 | MCS7 |
| 8 | MCS8 | MCS8 |
| 9 | MCS9 | MCS9 |
| 10 | MCS10 | MCS10 |
| 11 | MCS11 | MCS11 |
| 12 | MCS12 | MCS12 |
| 13 | MCS13 | MCS13 |
| 14 | MCS14 | MCS14 |
| 15 | MCS15 | MCS15 |
| 16 | MCS16 | MCS16 |
| 17 | MCS17 | MCS17 |
| 18 | MCS1 | MCS0 |
| 19 | MCS2 | MCS1 |
| . . . | . . . | . . . |
| 34 | MCS17 | MCS16 |
| 35 | MCS2 | MCS0 |
| 36 | MCS3 | MCS1 |
| . . . | . . . | . . |
| 50 | MCS17 | MCS15 |
| 51-63 | reserved | reserved |

Table 13 is an example of an MCS index table for describing the mixed MCS index. The values of the MCS field in the range from 0 to 17 mean that the MCSs used for the streams in the table are the same value as the value of the field for all streams, or in other words, are indications equivalent to EQM. Note that the correspondence relation between the MCS index indicated for each stream and the specific combination of a modulation scheme and a coding rate conforms to the UHR-MCS index described using Table 2.

The values of the MCS field in the range from 18 to 34 mean that the MCS used to modulate the last stream is one step lower in rate than the MCS used for the other stream(s). The values in the range from 35 to 50 mean that the MCS used to modulate the last stream is two steps lower than the MCS used for the other stream(s). In the second embodiment, the use of 6 bits makes it possible to represent a greater variety of MCS combinations. Note that the values in the range from 51 to 63 may also be used to represent a different MCS for each of stream 1, stream 2, and stream 3 in cases where there are three streams. For example, one value may be used to represent MCS15 for stream 1, MCS14 for stream 2, and MCS13 for stream 3. In cases where there are four or more streams, combinations may be defined in a similar manner such that the rate is lowered one step at a time for each of the streams.

### Third Embodiment

The third embodiment describes a modification in which the Spatial Configuration subfield is set to 5 bits, and this 5-bit subfield is used to convey the number of streams and the MCS for each stream.

Table 14 indicates an example of the user field communicated by communication devices 100 in the third embodiment, in place of the user field described using Table 7 in the first embodiment.

TABLE 14
User field for MU-MIMO transmission, UHR (modification 2)

| Bit | | No. of | |
|---|---|---|---|
| position | Subfield | bits | Description |
| B0-B10 | STA-ID | 11 | STA-ID of TXVECTOR parameter |
| B11-B15 | MCS | 5 | Value of MCS for UHR |
| B16 | EQM/UEQM | 1 | 0: EQM. 1: UEQM. |
| B17-B21 | Spatial | 5 | Allocation of number of spatial streams to each |
| | Configuration | | user for MU-MIMO |
| | | | Coding is implicitly understood to be LDPC. |

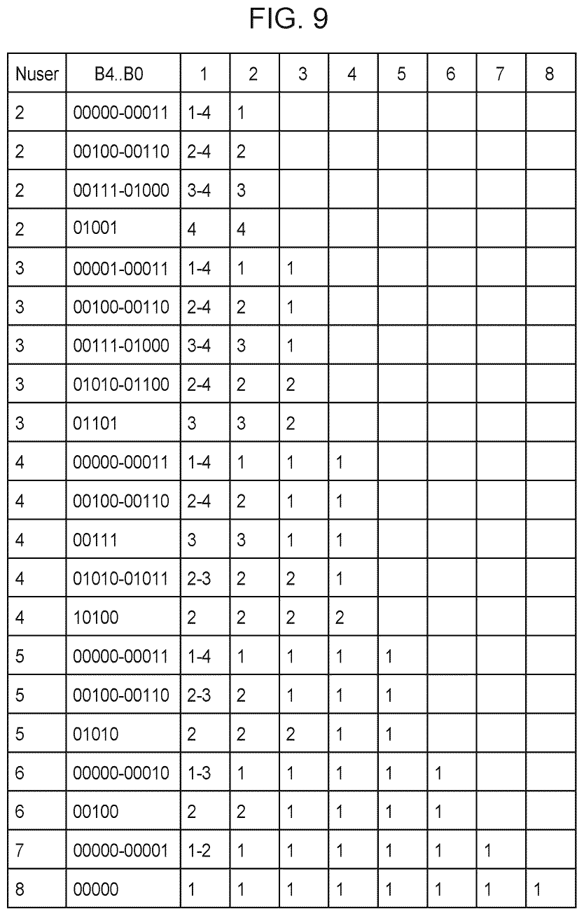

In the present embodiment, the 5-bit MCS subfield is used to indicate an MCS index that serves as a basis. A configuration is also adopted to indicate rate differences among individual streams in this case by utilizing the Spatial Configuration subfield. In a case where the EQM/UEQM subfield has a value of 0, the serialized indices indicated in FIG. 9 are used to indicate, in the Spatial Configuration subfield, the number of streams allocated to each communication device 100 designated as the destination of a wireless frame. FIG. 9 is a schematic diagram for explaining the Spatial Configuration subfield in the third embodiment. Also, in the case where the EQM/UEQM subfield has a value of 0, or in other words, in the case of using EQM, a common MCS is used for all streams. Consequently, a configuration may be adopted to transmit and receive data using the MCS that corresponds to the MCS index that serves as a basis indicated in the MCS subfield. That is, the communication device 100 on the transmitting side may transmit data by performing data modulating and encoding processing using the MCS that corresponds to the MCS index that serves as a basis indicated in the MCS subfield. The communication device 100 on the receiving side may then identify the MCS of the data from the MCS index that serves as a basis obtained by analyzing the preamble, and perform processing for demodulating and decoding the received Data 509 based on the identified MCS.

Note that Nuser in FIG. 9 is the number of communication devices 100 designated as the destination of a wireless frame, and is determined by the value indicated in the Number of Non-OFDMA Users (B17-B19) subfield in Table 10. Note that it is also possible to adopt a configuration such that the number of destination communication devices (Nuser) is identified by using the total number of user fields included in the User Specific field 712 illustrated in FIG. 7B or the like.

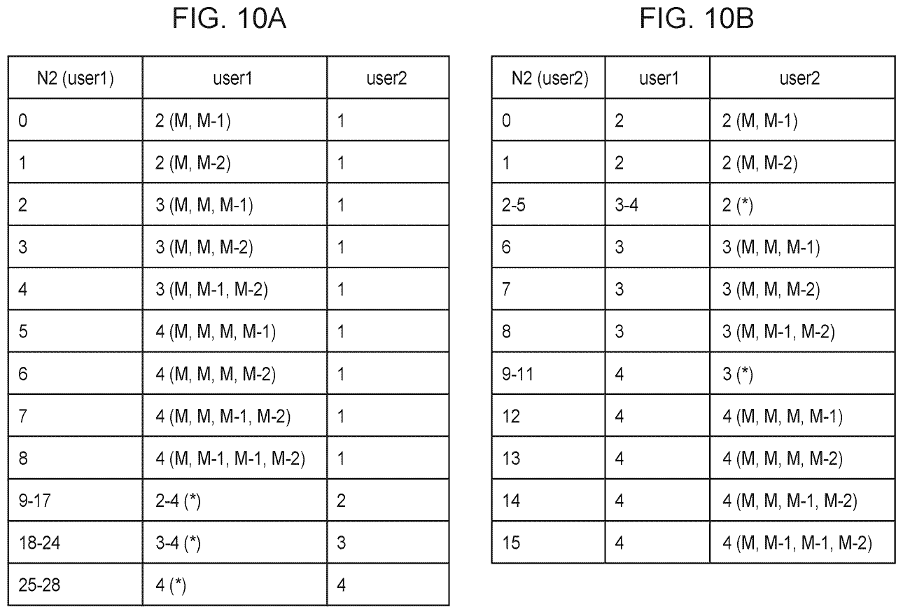

The following uses FIGS. 10A to 15 to describe a method for expressing the Spatial Configuration subfield in the case where the EQM/UEQM subfield has a value of 1.

FIGS. 10A and 10B are examples of correspondence tables for identifying UEQM from the Spatial Configuration subfield in the case where Nuser is 2 and the EQM/UEQM subfield in the user field corresponding to the device on the other side has a value of 1. A different correspondence table is used depending on the ordinal number, as counted from the beginning, of the user field included in the User Specific field 712 illustrated in FIG. 7B or the like. The following describes an example in which the user fields for the STA 111 and the STA 112 are conveyed in that order. The STA 111 corresponding to the first user field identifies UEQM and the streams allocated to itself based on the correspondence table in FIG. 10A. The STA 112 corresponding to the second user field identifies UEQM and the streams allocated to itself based on the correspondence table in FIG. 10B.

In a case where the Spatial Configuration subfield has a value of 0x0 (0b0000), two streams are allocated to the STA 111 and one stream is allocated to the STA 112. Furthermore, storing 0x0 in the first user field in the case where there are two users in total means that stream 1 addressed to STA 111 is modulated and encoded according to the MCS that corresponds to the MCS index indicated in the MCS subfield. The storage pattern described earlier also conveys that stream 2 is modulated and encoded according to the MCS one step lower in rate than the MCS index indicated in the MCS subfield. That is, M in the table means that the MCS index value indicated in the MCS subfield is to be used for the stream. M−1 indicates that the MCS one step lower in rate than the MCS corresponding to the MCS index value indicated in the MCS subfield is to be used. Similarly, M−2 indicates that the MCS two steps lower in rate than the MCS corresponding to the MCS index value indicated in the MCS subfield is to be used. The case where the Spatial Configuration subfield has a value of 0x7 (0b0111) means that four streams are allocated to the STA 111 and one stream is allocated to the STA 112. Furthermore, in regard to the MCS index value for each of the streams for the STA 111, storing 0x7 means that the MCS corresponding to the MCS index value indicated in the MCS subfield is to be used for streams 1 and 2. This also means that the MCS one step lower in rate than the MCS corresponding to the MCS index value indicated in the MCS subfield is to be used for stream 3. This also means that the MCS two steps lower in rate than the MCS corresponding to the MCS index value indicated in the MCS subfield is to be used for stream 4. The case where the Spatial Configuration subfield is assigned a value in the range from 9 to 17 indicates that two streams are allocated to the STA 112. In this case, the number of streams and the MCS index values for the STA 111 are assigned in a manner similar to 0-8. In the case of 18 to 24, three streams are allocated to the STA 112. The number of streams and the MCS index values for the STA 111 are assigned in a manner similar to 2-8. In the case where the Spatial Configuration subfield has a value in the range from 25 to 28, four streams are allocated to the STA 112. Four streams are allocated to the STA 111, and the MCS index values for these streams are assigned in a manner similar to 5-8. That is, by referring to FIG. 10A, the first user identifies the number of streams and the MCS for each stream. In addition, the STA 112 that corresponds to the second user refers to FIG. 10B using the value of the Spatial Configuration subfield that corresponds to the second user field. As a result of this referencing, the STA 112 identifies the indices of the streams allocated to itself, the number of streams, and the MCS for each stream.

It should be understood that in the case where one stream is allocated to the receiving-side device, it is naturally sufficient to convey that an EQM-like scheme is in effect. In other words, in the case where one stream is allocated to the receiving-side device, the communication device 100 on the transmitting side sets 0 in the EQM/UEQM subfield of the user field corresponding to the receiving-side device and performs signaling with the serialized values described using FIG. 9. That is, the number of allocated streams and the MCS are signaled to the receiving-side device by following former signaling of the number of streams. Therefore, it should be understood that the combinations illustrated in FIGS. 10A to 15 can be reduced in scope to serialized values that correspond to values limited to combinations in which two or more streams are assigned to the receiving-side device.

The STA 112 that corresponds to the second user references the second user field and determines whether or not UEQM is being used for data transmission to itself. If it is determined that UEQM is being used, the correspondence table in FIG. 10B and the value of the Spatial Configuration subfield in the second user field are used to identify the indices of the streams, the number of streams, and the MCS for each stream. The following gives an example of the identification method for the case where a value of 0 is stored in the Spatial Configuration subfield. In this case, the STA 112 references the correspondence table in FIG. 10B and identifies that two streams corresponding to the third and fourth indices are allocated to itself. The STA 112 also identifies that the MCS that is one step lower in rate than the MCS that serves as a basis is assigned to the second stream addressed to itself. In the case where 1 is stored, the STA 112 identifies that the MCS that is two steps lower in rate than the MCS that serves as a basis is assigned to the second stream addressed to itself.

Subsequently, storing a value of 2 or 3 in the Spatial Configuration subfield means that three streams are allocated to the STA 111 and two streams are allocated to the STA 112. The values 2 and 3 differ in the degree to which the rate is lowered for the second stream allocated to the STA 112. Storing a value of 4 or 5 means that four streams are allocated to the STA 111 and two streams are allocated to the STA 112. The values 4 and 5 differ in the degree to which the rate is lowered for the second stream.

Subsequently, by similar thinking, storing a value of 6-11 in the Spatial Configuration subfield means that three streams are allocated to the STA 112. Also, the specific value stored from among 6-11 can be used to differentiate the degree to which the rate is lowered for the second and third streams in the case where three streams are allocated to the STA 112. Storing a value of 12-15 in the Spatial Configuration subfield means that four streams are allocated to the STA 112. Also, the specific value stored from among 12-15 can be used to differentiate the degree to which the rate is lowered for the second and subsequent streams.

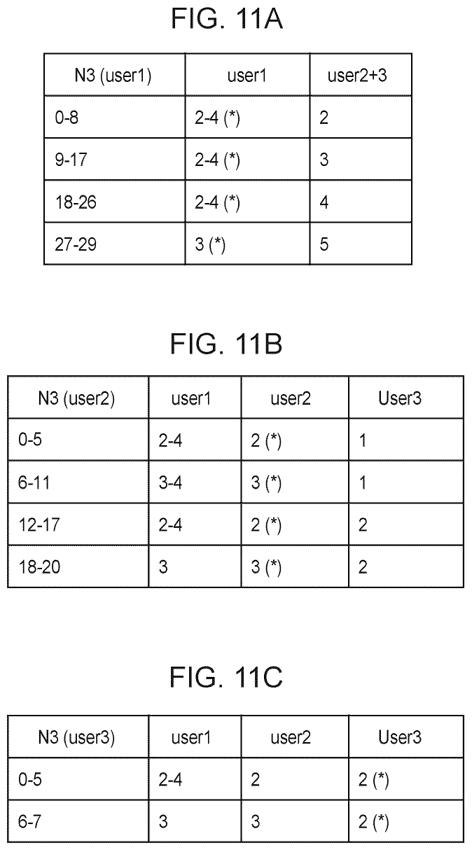

Next, FIGS. 11A to 11C are an example of correspondence tables to be used to interpret the Spatial Configuration subfield in a case where Nuser is 3 and the EQM/UEQM subfield in the user field has a value of 1. The MCS notation in the tables is similar to FIGS. 10A and 10B. The communication device on the receiving side interprets the serialized value of the Spatial Configuration subfield by using a different correspondence table depending on the ordinal position of the user field and whether the value of the EQM/UEQM subfield is 0 or 1. FIG. 11A illustrates the correspondence table to be referenced by the first user in the case where 1 is set in the EQM/UEQM subfield. FIG. 11B illustrates the correspondence table to be referenced by the second user in the case where 1 is set in the EQM/UEQM subfield. FIG. 11C illustrates the correspondence table to be referenced by the third user in the case where 1 is set in the EQM/UEQM subfield.

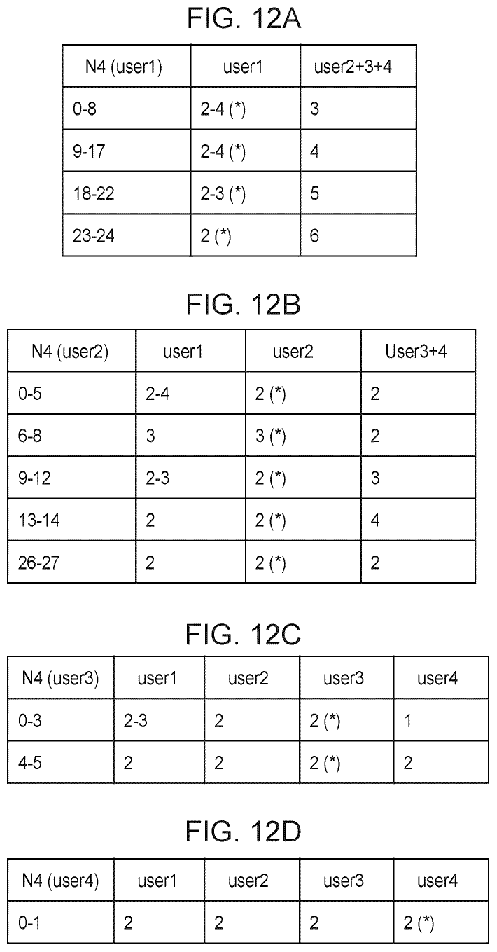

As an example, the following describes the identification of communication parameters in a case where Nuser is 3, the EQM/UEQM subfield in the first user field has a value of 1, and the Spatial Configuration subfield has a value of 7. The communication device that corresponds to the first user identifies that four streams are allocated to itself. Next, the communication device that corresponds to the first user identifies that the respective MCSs for the streams are, in order, M, M, M−1, M−2, where M is the MCS that corresponds to the value indicated in the MCS subfield. The value of 7 also serves as an indication that a total of two streams are allocated to the second and third communication devices 100. The communication device that corresponds to the second user field similarly references the correspondence table in FIG. 11B and identifies the number of streams allocated to itself and the MCS for each stream. The communication device that corresponds to the third user field references the correspondence table in FIG. 11B and identifies the number of streams allocated to itself and the MCS for each stream. Note that the communication device on the transmitting side determines the values to be included in the user fields of the preamble by the reverse procedure. That is, the communication device 100 on the transmitting side first determines the number of users involved in simultaneous communication, the number of streams to be allocated to each user, the MCS to serve as a basis, and whether UEQM is to be used or not. To make this determination, a history of communication with the receiving-side devices, received signal strength indicators, and/or the like can be used. The MCS index to be signaled in the preamble and the serialized value to be stored in the Spatial Configuration subfield may then be determined using the correspondence tables described using FIGS. 9 to 11C, and the UHR MU PPDU may be transmitted. Note that the cases where four or more users are involved in simultaneous transmission, which are illustrated in FIGS. 12A to 15, likewise may adopt a configuration such that a preamble is generated and multiplexed data is transmitted according to a similar procedure. For simplicity in the description that follows, the Spatial Configuration subfield is also referred to as the SC field.

Next, FIGS. 12A to 12D illustrate correspondence tables to be used in the case where Nuser is 4. The table notation is similar to FIGS. 10A, 10B, and the like. The correspondence table to be used differs depending on the ordinal position of the user field and whether the value of the EQM/UEQM subfield is 0 or 1. FIG. 12A illustrates an example of a correspondence table for the case where UEQM is applied to the first user, FIG. 12B illustrates an example of a correspondence table for the case where UEQM is applied to the second user, and FIG. 12C illustrates an example of a correspondence table for the case where UEQM is applied to the third user. FIG. 12D illustrates an example of a correspondence table for the case where UEQM is applied to the fourth user.

Applying UEQM to the first user and storing 7 in the SC field means that four stream are allocated to the communication device that corresponds to the first user and the respective MCS for the streams are, in order, M, M, M−1, M−2, where M is the basis MCS. The value also serves as an indication that a total of three streams are allocated to the second to fourth communication devices 100. The number of streams allocated to each of the second to fourth users and the MCS for each stream can also be identified according to a similar procedure.

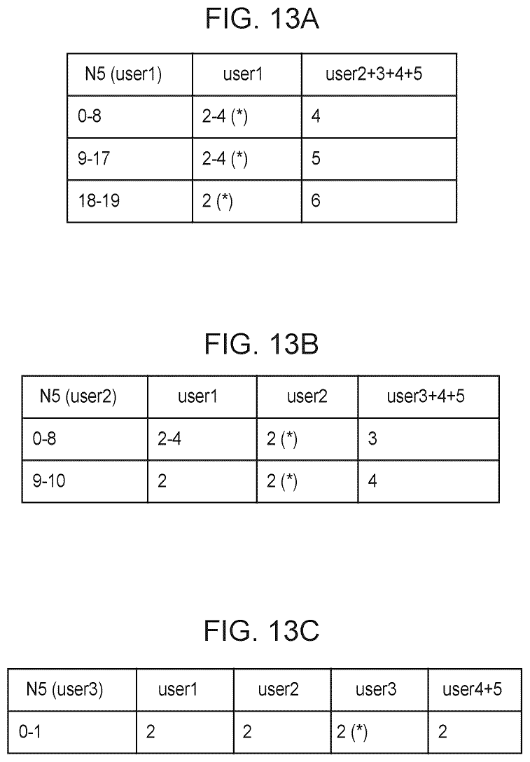

FIGS. 13A to 13C illustrate an example of the case where Nuser is 5. The correspondence table to be used differs depending on the ordinal position of the user field and whether the value of the EQM/UEQM subfield is 0 or 1. FIG. 13A illustrates an example of a correspondence table for the case where UEQM is applied to the first user, FIG. 13B illustrates an example of a correspondence table for the case where UEQM is applied to the second user, and FIG. 13C illustrates an example of a correspondence table for the case where UEQM is applied to the third user.

In the present embodiment, MU-MIMO communication with up to eight streams is assumed. In a case where streams are allocated to five users, one stream is always allocated to each of the communication devices that correspond to the fourth and fifth user fields, as also indicated in the former stream allocation illustrated by way of example in FIG. 9. Consequently, the communication device 100 that transmits the UHR MU PPDU in MU-MIMO format always sets 0 as the value of the EQM/UEQM subfield in the fourth and fifth user fields. A communication device on the receiving device that has determined that its own STA-ID is stored in the fourth or fifth user field references FIG. 9 to identify the index of the stream allocated to itself. This communication device then performs demodulation and decoding processing on the assumption that the data of the single stream corresponding to the identified index has been modulated and encoded according to the basis MCS.

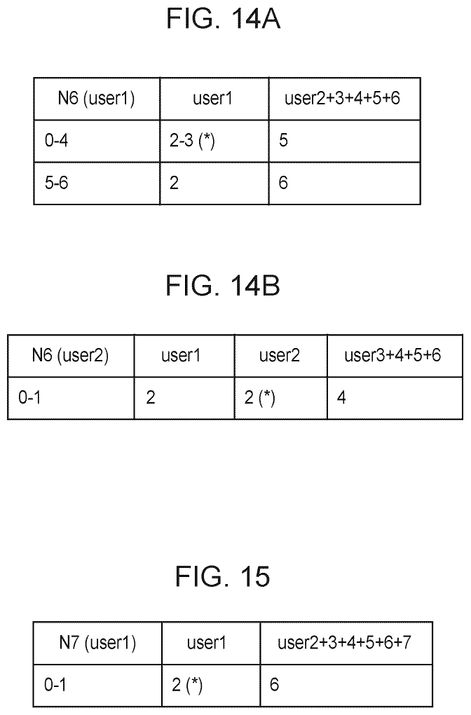

FIGS. 14A and 14B illustrate an example of the case where Nuser is 6. The correspondence table to be used differs depending on the ordinal position of the user field and whether the value of the EQM/UEQM subfield is 0 or 1. FIG. 14A illustrates an example of a correspondence table for the case where UEQM is applied to the first user, and FIG. 14B illustrates an example of a correspondence table for the case where UEQM is applied to the second user. Since one stream is allocated to each of the third and subsequent users, EQM is always applied and a value corresponding to FIG. 9 is stored in the SC field. FIG. 15 illustrates an example of the case where Nuser is 7. The correspondence table to be used differs depending on the ordinal position of the user field and whether the value of the EQM/UEQM subfield is 0 or 1. FIG. 15 illustrates an example of a correspondence table for the case where UEQM is applied to the first user. Since one stream is allocated to each of the second and subsequent users, EQM is always applied and a value corresponding to FIG. 9, namely 00000 or 00001, is stored in the SC field. For example, if the EQM/UEQM subfield in the first user field has a value of 1 and the SC field has a value of 1, two streams are allocated to the device to which the user field corresponds.

The MCSs for the two allocated streams are, in order, M, M−2, where M is the MCS that corresponds to the value indicated in the MCS subfield. The value of the SC field also serves as an indication that a total of six streams are allocated to the second to seventh communication devices 100.

As described above, revising the handling of the SC field makes it possible to indicate the number of streams and UEQM using fewer bits. More specifically, interpreting the meaning of the serialized values differently depending on the position of the user field makes it possible for the 5-bit SC field to also denote the MCS index value for each stream in the case of using UEQM. Furthermore, as in the second embodiment, it is also naturally possible to adopt a modification in which the MCSs and number of streams for UEQM are signaled using a 6-bit field that combines the EQM/UEQM subfield and the SC field. In the case of adopting the technique of the third embodiment, an advantageous effect is obtained whereby the number of variations of the MCS for each stream can be increased by taking advantage of the low entropy conveyed by the former Spatial Configuration subfield. In other words, it is possible to increase the number of variations by which a different MCS is adopted for each stream. For example, it is possible to express the pattern of using M, M−1, M−1, M−2 in the case of four streams, which could not be adopted in the first or second embodiment due to the constraint on the number of combinations.

### Fourth Embodiment

In the fourth embodiment, the four subfields of the MCS subfield, the EQM/UEQM subfield, the Spatial Configuration subfield, and the UEQM pattern variations subfield are provided within the User field. The following describes a mechanism for signaling differences in the MCS for each stream according to the value stored in the UEQM pattern variations subfield. In the present embodiment, the system configuration as well as the hardware configuration and the functional configuration of the communication device are similar to those of the first embodiment, and thus a description of these configurations is omitted. Note that the present embodiment differs from the first embodiment in that the configuration of the user field is different.

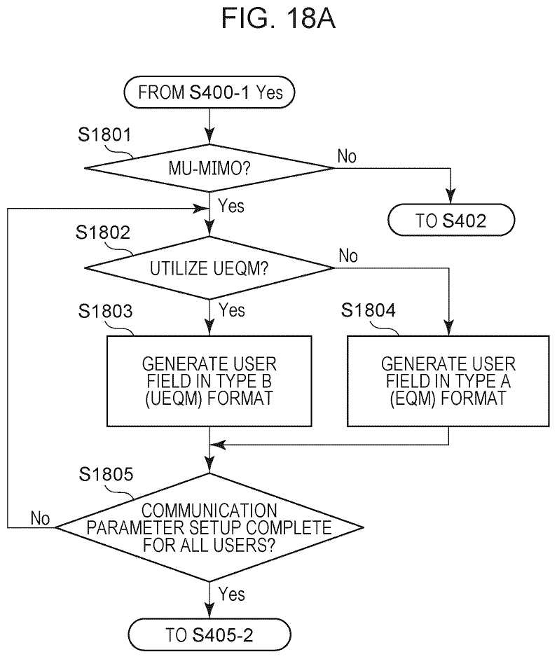

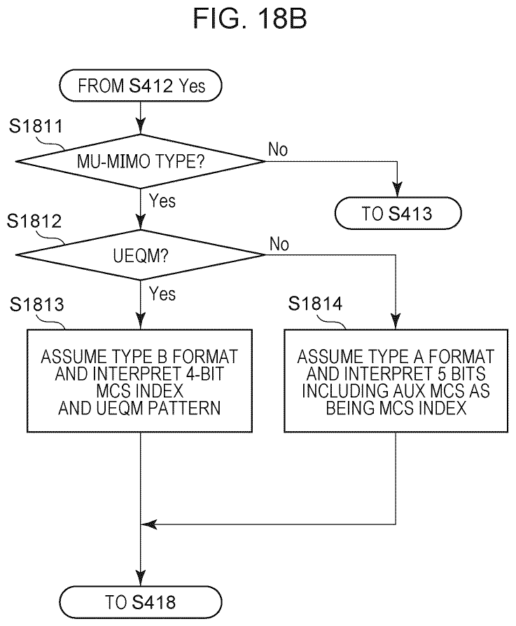

Specific control of communication will be described using FIGS. 18A and 18B. FIG. 18A is a flowchart illustrating an example of PPDU transmission control processing, and FIG. 18B is a flowchart illustrating an example of PPDU reception control processing. Each operation (step) illustrated in the flowcharts in FIGS. 18A and 18B is achieved by having the control unit 202 execute a program stored in the storage unit 201. In cases where the control provided by a functional component corresponding to the program is to be clearly indicated, the corresponding functional unit is used as the grammatical subject of the description. Also, some processes are achieved by having a functional unit achieved by the control unit 202 cooperate with hardware.

Note that since control for the transmission and reception of data should be supported by both the AP and the STA, FIGS. 18A and 18B illustrate such control without distinguishing between the control on the AP side and the control on the STA side. In other words, the AP 101 and the STA 111 that support the first standard (for example, IEEE 802.11bn) carry out the control illustrated in FIGS. 18A and 18B. The flowchart in FIG. 18A illustrates additional control incorporated into the transmission control indicated in the flowcharts in FIGS. 4A and 4B described in the first embodiment. Specifically, the flowchart in FIG. 18A illustrates alternative control to be performed upon determining to perform MU-MIMO transmission. The flowchart in FIG. 18A illustrates additional control incorporated into the transmission control indicated in the flowcharts in FIGS. 4A and 4B described in the first embodiment. Specifically, the flowchart in FIG. 18A illustrates alternative control to be performed upon determining to perform non-OFDMA MU-MIMO transmission.

In S1801, the control unit 302 cooperates with the generation unit 303 to determine whether or not to transmit data to multiple communication devices by MU-MIMO. If it is determined to transmit data to multiple communication devices by MU-MIMO, the processing is advanced to S1802. On the other hand, if it is not determined to transmit data to multiple communication devices by MU-MIMO, the processing is advanced to S402, and the processing for configuring and transmitting a PPDU described in the first embodiment is performed.

S1802 to S1805 indicate the processing for generating each user field of the UHR-SIG for MU-MIMO. The processing from S1802 to S1804 is executed repeatedly a number of times equal to the number of counterpart communication devices to communicate with simultaneously.

In S1802, the control unit 302 determines whether or not to utilize UEQM for data transmission to the user for whom a user field is to be generated. If it is determined to utilize UEQM for data transmission to the user for whom a user field is to be generated, the processing is advanced to S1803. If it is determined not to utilize UEQM for data transmission to the user for whom a user field is to be generated, the processing is advanced to S1804.

In S1803, the control unit 302 cooperates with the generation unit 303 to generate a user field in Type B format, and advances the processing to S1805. On the other hand, in S1804, the control unit 302 cooperates with the generation unit 303 to generate a user field in Type A format, and advances the processing to S1805. The formats will be described later.

Lastly, in S1805, the control unit 302 cooperates with the generation unit 303 to determine whether or not user field generation is complete for all users corresponding to the counterpart communication devices to communicate with simultaneously. If it is determined that user field generation is complete for all users, the control unit 302 advances the processing to S405-2. On the other hand, if it is not determined that user field generation is complete for all users, the control unit 302 advances the processing to S1802 and advances the processing to processing for generating a user field for signaling communication parameters to a different counterpart communication device.

### Details of Type A Format and Type B Format

In the third embodiment, an example of the configuration of the user field to be used in the case of MU-MIMO communication is indicated in Table 15. Table 15 indicates an example of the user field to be used instead of the user field in Table 7 of the first embodiment. Table 15 differs from the example indicated in Table 7 in that the MCS subfield is 4 bits and the Spatial Configuration subfield is 4 bits. Table 15 also differs in that the EQM/UEQM subfield is used to implicitly distinguish the user field format. Furthermore, Table 15 differs in that a 2-bit UEQM pattern variations/AUX MCS and Coding subfield is newly defined.

TABLE 15
User field for MU-MIMO transmission, UHR (fourth embodiment)

| Bit | | No. of | |
|---|---|---|---|
| position | Subfield | bits | Description |
| B0-B10 | STA-ID | 11 | STA-ID of TXVECTOR parameter |
| B11-B14 | MCS | 4 | Value of MCS for UHR |
| B15 | EQM/UEQM | 1 | 0: EQM. 1: UEQM. |
| | | | Specifying 0 implicitly indicates Type A format, in |
| | | | which case B20-B21 indicate information |
| | | | corresponding to AUX MCS and Coding. |
| | | | Specifying 1 implicitly indicates Type B format, in |
| | | | which case B20-B21 indicate the UEQM pattern. |
| B16-B19 | Spatial | 4 | Allocation of number of spatial streams to each user |
| | Configuration | | for MU-MIMO |
| B20-B21 | UEQM pattern | 2 | [If UEQM] |
| | variations/ | | Specifies UEQM pattern. Coding is implicitly |
| | AUX MCS and | | understood to be LDPC. |
| | Coding | | [If EQM] |
| | | | B20 is auxiliary bit to be combined with MCS |
| | | | subfield. |
| | | | B21 indicates Coding. 0: BCC. 1: LDPC. |

In the present embodiment, different information is conveyed by the B20-B21 subfield depending on the value stored in the EQM/UEQM subfield. Setting 1 in the EQM/UEQM subfield also functions as an indicator implicitly conveying that the user field is in Type B format, in which case B20-B21 are to be interpreted as being a UEQM pattern variations subfield. Setting 0 in the EQM/UEQM subfield also functions as an indicator implicitly conveying that the user field is in Type A format, in which case B20-B21 are to be interpreted as being an AUX MCS and Coding subfield.

The configured MCS index value is stored in the 4-bit MCS subfield in B11-B14. To avoid confusion with the 5-bit MCS subfield, this field may also be given a different name, such as the Legacy MCS subfield. In the case of Type A format, this 4-bit MCS subfield stores one of the 4-bit MCS indices used by the IEEE 802.11be standard indicated in Table 1. In the case of Type B format, this 4-bit MCS subfield stores 4 out of 5 bits starting from the LSB constituting a portion of an MCS index made up of 5 bits in combination with an AUX MCS in B20.

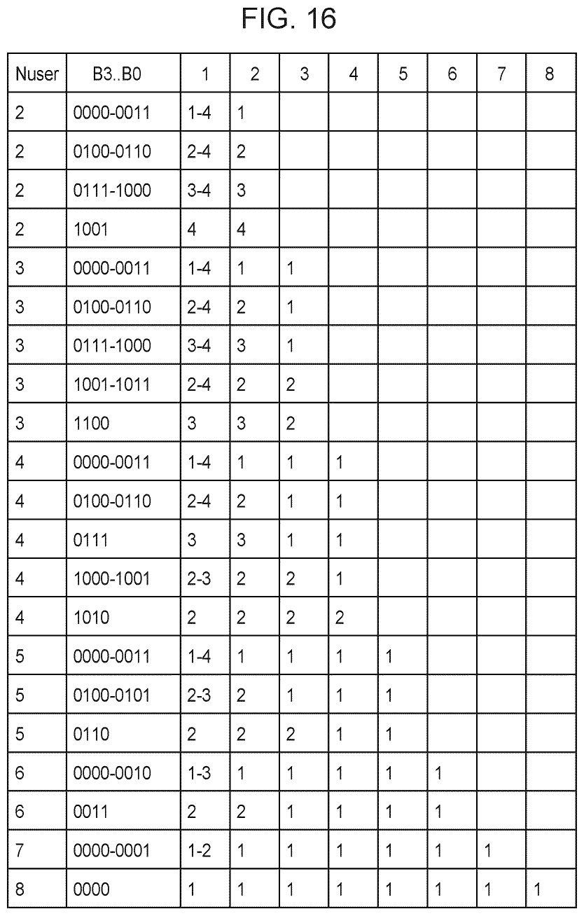

The Spatial Configuration subfield is made up of 4 bits, and this subfield stores one of the serialized values indicated in FIG. 16. For simplicity in the description that follows, the Spatial Configuration subfield is also referred to as the 4-bit SC field. FIG. 16 illustrates an example of a correspondence table of the numbers of streams to be allocated to destination communication devices 100. A value from this correspondence table is stored in the 4-bit SC field. The value of Nuser corresponds to 1 plus the value indicated in the Number of Non-OFDMA Users subfield in B17-B19 of the Common field described using Table 10 of the first embodiment. That is, Nuser corresponds to the number of users involved in simultaneous transmission. FIG. 16 differs from FIG. 9 in that a modification is adopted to reduce the number of bits by 1 and convey allocations of up to 8 streams in 4 bits. The communication device on the transmitting side uniquely conveys the number of streams allocated for communication with a counterpart communication device according to the value of the 4-bit SC field, a value corresponding to Nuser, and the overall ordinal position where the user field of the counterpart communication device is stored. For example, specifying a value corresponding to Nuser 2 in the Common field and specifying 0011 in the 4-bit SC field means that four streams are allocated to the user corresponding to the first user field. The above also means that one stream is allocated to the user corresponding to the second and subsequent user fields.

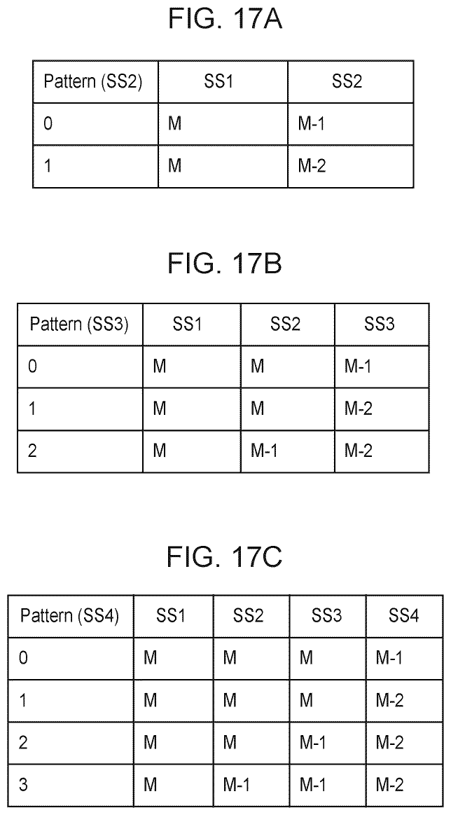

Next, FIGS. 17A to 17C will be used to describe correspondence tables of the MCS index for each stream indicated in the UEQM pattern variations subfield to be used in the case of Type A format. FIGS. 17A to 17C illustrate an example of correspondence tables for identifying the MCS for each stream based on the value of the MCS subfield and the value of the UEQM pattern variations subfield. In a case where two streams are allocated for data transmission to a counterpart communication device, the communication device on the transmitting side uses the correspondence table corresponding to FIG. 17A to determine a pattern that represents the difference between the respective MCSs for the streams. In a case where there are three streams, the correspondence table corresponding to FIG. 17B is used to determine a pattern that represents the differences among the respective MCSs for the streams. In a case where there are four streams, the correspondence table corresponding to FIG. 17C is used to determine a pattern that represents the differences among the respective MCSs for the streams. Note that the specific MCS pattern to be used for communication may be determined based on a factor such as the communication quality with the counterpart communication device.

The following describes an example in which UEQM is utilized and two streams are allocated.

In this example, indicating 0 in the UEQM pattern variations subfield means that the respective MCSs for the streams are, in order, M, M−1, where M is the value indicated in the MCS subfield. This is as indicated in FIG. 17A. Also, in a case where three streams are allocated, indicating 1 in the UEQM pattern variations subfield means that the respective MCSs for the streams are, in order, M, M, M−2, where M is the value indicated in the MCS subfield. This is as indicated in FIG. 17B. By similar thinking, in a case where four streams are allocated, the MCS to be used for each stream likewise can be identified based on the MCS corresponding to the MCS index stored in the MCS subfield according to patterns 0 to 3. This is as indicated in FIG. 17C. Also, in the case of Type A format, both the communication device on the receiving side and the communication device on the transmitting side are assumed to perform encoding and decoding based on the common understanding that low-density parity check (LDPC) is implicitly used for the Coding of the data portion.

Next, the AUX MCS and Coding subfield indicated in B20-B21 of Table 15 stored in the user field of Type B format will be described.

In the case of Type B format, the AUX MCS in B20 stores 1 out of 5 bits starting from the MSB constituting a portion of the UHR MCS index made up of 5 bits. In other words, the 4 bits of B11-B14 and the 1 bit of B20 can be combined to indicate the value of the 5-bit MCS index corresponding to the UHR-MCS indicated in Table 2. The way in which the bits are split is an example. It is naturally also possible to store 4 bits starting from the MSB in the 4-bit MCS subfield and store 1 bit starting from the LSB in B20 indicating the AUX MCS. Also, information indicating whether the coding scheme uses binary convolutional code (BCC) or LDPC is indicated in the Coding field in B21.

Lastly, FIG. 18B will be used to briefly describe control additionally incorporated into the communication device 100 on the receiving side. In S1811, the control unit 302 cooperates with the analysis unit 306 to analyze the preamble of the received UHR PPDU. If it is determined that the type of the received UHR PPDU is the MU-MIMO type, the processing is advanced to S1812. On the other hand, if it is determined that the type of the received UHR PPDU is not the MU-MIMO type, the processing is advanced to S413, and the processing for interpreting and receiving a PPDU described in the first embodiment described earlier is performed. Specifically, the analysis unit 306 can identify the type of UHR PPDU based on, among other things, the value of the PPDU Type and Compression Mode field included in the U-SIG of the received UHR PPDU.

In S1812, the control unit 302 cooperates with the analysis unit 306 to identify the user field that corresponds to its own STA-ID. If there is no user field associated with its own STA-ID, the control unit 302 discards the PPDU being received, and ends the series of reception processing operations. Next, if there is a user field that corresponds to its own STA-ID, the control unit 302 references the value of the UEQM/EQM subfield stored in the subfield to determine whether or not UEQM is used. If 1 is set in the UEQM/EQM subfield, it is determined that UEQM is used, and the processing is advanced to S1813. If 0 is set in the UEQM/EQM subfield, it is determined that UEQM is not used (in other words, it is determined that EQM is used), and the processing is advanced to S1814. Also, in conjunction with the identification of whether or not its own user field is present, the control unit 302 also identifies the ordinal position of its own user field among all user fields, and temporarily stores position information about the same. This position information is used for identification of the UEQM pattern correspondence table in the processing in S1813.

In S1813, the control unit 302 cooperates with the analysis unit 306 interprets the user field as Type B format. In other words, the control unit 302 interprets that a MCS index that serves as a basis corresponding to EHT-MCS, which is a 4-bit MCS index, is specified. The control unit 302 then references the correspondence table indicated in Table 1 based on the MCS index, and interprets the MCS that serves as a basis. Next, the control unit 302 identifies the number of streams allocated to itself based on the temporarily stored position information and the value of the 4-bit SC field. Additionally, the value of the UEQM pattern variations subfield in B21-B22 is used to reference the UEQM correspondence table (one of FIGS. 17A to 17C) that corresponds to the identified number of streams. Additionally, the MCS to be used for another stream different from the main stream is uniquely identified (interpreted) based on the MCS pattern obtained by the referencing and the MCS that serves as a basis. Upon completion of interpretation, the control unit 302 advances the processing to S418 and performs the demodulation and decoding of the data signal described earlier using, as parameters, the MCS (modulation scheme and coding rate) obtained as a result of the interpretation processing. The name given to the UEQM pattern variations subfield is an example, and this subfield may also be referred to as the UEQM pattern subfield or the like.

In S1814, the control unit 302 cooperates with the analysis unit 306 interprets the user field as Type A format. In other words, the control unit 302 interprets that an MCS index that serves as a basis corresponding to the UHR-MCS made up of 5 bits combining the 4-bit MCS index and the 1-bit AUX MCS is specified, references the correspondence table indicated in Table 2, and interprets the MCS that serves as a basis. The control unit 302 then cooperates with the analysis unit 306 to interpret that all streams allocated to itself are modulated and encoded according to the MCS that serves as a basis, and advances the processing to S418.

As described above, even in the case of a configuration in which signaling control is performed by using the UEQM pattern variations subfield, the use of a different MCS for each stream can be conveyed to the communication device on the other end. Also, to secure sufficient fields, in the case of MU-MIMO and UEQM, the MCS subfield is deliberately limited to 4 bits. Deliberately imposing a constraint in this way makes it possible to convey UEQM of MU-MIMO appropriately while also adopting a frame design that maintains the same total number of bits in the user encoding block as the previous standard. Also, in the case of MU-MIMO and EQM, it is also possible to utilize the MCSs newly defined in IEEE 802.11bn by combining the MCS subfield with the AUX MCS subfield.

Note that the value of the MCS subfield may also be the difference from the value of the MCS field used in a previous non-MU-MIMO frame. For example, a value of 0 means to use the previous MCS as-is. Also, if B3-B0 are 1, the meaning is negative 1, which means to use the value obtained by subtracting 1 from the MCS used previously. If only B0 is 1, the meaning is to use the value obtained by adding 1 to the MCS used previously. Whether to use these indications of difference or to use the UHR-MCS index may be determined based on prior negotiation between the STA and the AP.

In the embodiments described above, in consideration of simultaneous communication or the like from a STA to multiple access points, the STA is configured to be capable of transmitting MU-MIMO PPDUs to multiple access points or the like. However, the configuration is not limited to the above. It is naturally also possible to have the STA not transmit MU-MIMO frames, and perform the MU-MIMO frame reception control illustrated in FIG. 18B but not perform the MU-MIMO frame transmission control.

Furthermore, it is also possible to adopt a configuration such that an indication corresponding to the UEQM pattern variations subfield and the EQM/UEQM subfield is conveyed in a total of 2 bits. In this case, 5 bits can be secured for the MCS subfield. However, the trade-off is that UEQM variations are more constrained. Specifically, within the correspondence tables for the UEQM pattern variations subfield, a value of 0 is reinterpreted to mean EQM. A value of 1 is reinterpreted to mean pattern “0” in the correspondence tables of FIGS. 17A to 17C. A value of 2 is reinterpreted to mean 1 in the correspondence tables of FIGS. 17A to 17C. A value of 3 is reinterpreted to mean 2 in the correspondence tables of FIGS. 17A to 17C.

### Modification 1

Note that in the embodiments described above, a configuration is adopted such that, in a case of transmitting data by what is called SU-MIMO in which a value equal to or greater than 1 is specified in NSS of the user field indicated by way of example in Table 6, the MCS for each stream is identified using the MCS index indicated by way of example in Table 8. However, the configuration is not limited to the above and may also be modified such that the concepts of the fourth embodiment are also applied to UEQM for SU-MIMO.

Table 16 indicates an example of the user field to be used instead of the user field in Table 6 of the first embodiment. Table 16 also differs from the example indicated in Table 6 in that the EQM/UEQM subfield is used to implicitly distinguish the user field format. Furthermore, Table 16 differs in that a 2-bit UEQM pattern/Beamformed and Coding subfield is newly defined.

TABLE 16
User field for non-MU-MIMO transmission, UHR

| Bit | | No. of | |
|---|---|---|---|
| position | Subfield | bits | Description |
| B0-B10 | STA-ID | 11 | STA-ID of TXVECTOR parameter |
| B11-B15 | MCS | 5 | Value of MCS for UHR |
| B16-B18 | NSS | 3 | Value is number of spatial streams minus 1. |
| | | | If STA-ID is 2046, may be set to any value. |
| B19 | EQM/UEQM | 1 | 0: EQM. 1: UEQM. |
| B20-21 | UEQM | 2 | [If UEQM] |
| | Pattern/Beamformed and | | Specifies UEQM pattern. Coding is implicitly |
| | Coding | | understood to be LDPC. |
| | | | [If EQM] |
| | | | B20 indicates the following: |
| | | | 1 if applying beamforming steering matrix to |
| | | | non-MU-MIMO waveform; 0 otherwise. If |
| | | | STA-ID is 2046, may be set to any value. |
| | | | B21 indicates the following: |
| | | | 0: BCC. 1: LDPC. |
| | | | If STA-ID is 2046, may be set to any value. |

In the present embodiment, different information is conveyed by the B20-B21 subfield depending on the value stored in the EQM/UEQM subfield. Setting 1 in the EQM/UEQM subfield also functions as an indicator implicitly conveying that the user field is in Type B format, in which case B20-B21 are to be interpreted as being a UEQM pattern variations subfield. Setting 0 in the EQM/UEQM subfield also functions as an indicator implicitly conveying that the user field is in Type B format, in which case B20-B21 are to be interpreted as being a Beamformed and Coding subfield. In this case, B20 indicates a value indicating whether or not beamforming is performed, and B21 indicates the coding algorithm.

According to this modification, the parameter interpretation for MU-MIMO and SU-MIMO can be made uniform when utilizing UEQM to perform MIMO communication, which exhibits the advantageous effect of simplifying the design. In this case, the communication device on the transmitting side carries out additional control to determine whether or not to perform transmission of the SU-MIMO type. Having determined to perform transmission of the SU-MIMO type, the communication device on the transmitting side then generates a user field storing communication parameters according to the field design indicated in Table 16, and transmits the UHR MU PPDU. On the other hand, the communication device on the receiving side carries out additional control to determine whether or not the received UHR MU PPDU is of the SU-MIMO type. Having determined that the received UHR MU PPDU is of the SU-MIMO type, the communication device on the receiving side may be configured to reference the value of the EQM/UEQM subfield and interpret B20-B21 differently in accordance therewith. Note that a configuration may also be adopted such that NSS is reduced to 2 bits and the Type B format is also provided with a field for conveying information corresponding to Beamformed. In this case, up to four SU-MIMO streams are supported.

### Modification 2

The embodiments described above give an example in which an indication of whether the coding scheme uses BCC or LDPC is conveyed in a subfield/bit corresponding to Coding. However, considering that all communication devices supporting IEEE 802.11bn may be configured to have mandatory support for LDPC, a modification may also be adopted such that 0 indicates LDPC. In this case, a modification may be adopted such that indicating 1 in a subfield/bit corresponding to Coding means that encoding is performed using 2×LDPC, which refers to a parity check code using a larger matrix than formerly.

### Modification 3

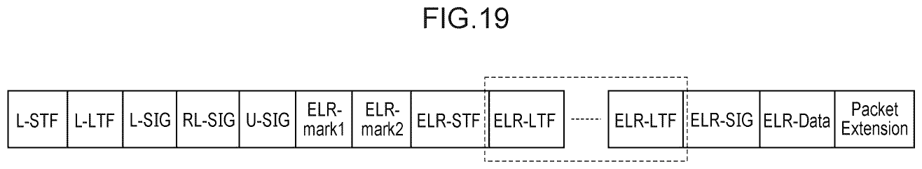

IEEE 802.11bn defines a new PPDU format referred to as Enhanced Long Range (ELR) frames, which are frames for achieving reliable communication with more distant devices. In the following, these frames are referred to as the UHR ELR PPDU. ELR frames make more reliable communication possible by having a PHY (Physical) preamble and PHY layer transmission method that are altered from conventional frames. FIG. 19 illustrates an example of the preamble configuration of the UHR ELR PPDU. Part of the configuration is different, but the end is PE in the same manner as other UHR PPDUs. It is conceivable to configure this ELR PPDU to support only BPSK with coding rate R=1/2 (corresponding to EHT-MCS1) and QPSK with coding rate R=1/2 (corresponding to EHT-MCS2). In the above case, it is also conceivable to apply a concept similar to formerly used DCM and replicate the same data in the frequency domain. In other words, it is also conceivable to make more reliable communication possible by transmitting the same data redundantly in the frequency domain using allocated frequency resources. In the above case, it is also possible to modify the configuration such that the MCS subfield of the ELR-SIG is used to convey information such as the number of replications. That is, in the case of transmitting by the UHR ELR PPDU format, a configuration may be similarly adopted such that different meanings are given to the serialized values of the MCS index to be included in the MCS subfield. In an ELR frame, the transmission method for L-STF/L-LTF for example is altered (by applying a 3 dB power boost, for example) to indicate that the frame is ELR. Also, in an ELR frame, PHY Version Identifier of the U-SIG field is set to a value of 1. Also, in an ELR frame, the value of the PPDU Type And Compression Mode field is set to a value specifying that the PPDU is an ELR PPDU. This value is, for example, “3”, as indicated by way of example in Table 3. The information in the U-SIG likewise may be used to specify that the frame is an ELR frame. Also, considering that the preamble configuration was designed such that the ELR-SIG is placed at the rear of the training field, a configuration may be adopted such that the version-dependent fields within the U-SIG are provided with one STA-ID field for identifying the destination. However, this is an example, and naturally it is also possible to adopt a configuration such that STA-ID is included in the ELR-SIG. Two ELR-Mark symbols are known sequence bits for ELR mode classification. The ELR-Mark symbol carries BSS color information in the ELR-Mark sequence. Also, a power boost is not applied to these ELR-Mark symbols. The two Mark symbols are modulated by QBPSK. In the case of an ELR frame, communication parameters are signaled to individual communication devices by the ELR-SIG illustrated in FIG. 19 instead of the UHR-SIG. Within the ELR-SIG, the MCS subfield is made up of 2 bits. In the following, this subfield is also referred to as the ELR-MCS field for the sake of explanation. A value of 0 may indicate that four replications of a Resource Unit (RU) 52 contained within 20 MHz are transmitted using EHT-MCS0 based on Table 1. Otherwise, a configuration may also be adopted such that a value of 1 indicates that four replications of the RU 52 are transmitted using EHT-MCS1. A configuration may also be adopted such that a value of 2 indicates that nine replications of an RU 26 are transmitted using EHT-MCS0. A configuration may also be adopted such that a value of 3 indicates that nine replications of an RU are transmitted using EHT-MCS1.

On the other hand, as described earlier, for a non-ELR format frame such as the UHR MU PPDU, UHR-MCS is conveyed using the user field in the preamble, using MCS subfields of 4 bits or more. Similarly, for a non-ELR format frame such as the EHT MU PPDU, the 4-bit MCS subfield is used to perform signaling of the EHT-MCS based on Table 1.

In this way, in the present modification, in a case of transmitting an ELR frame, an MCS subfield bit configuration with fewer than 4 bits is adopted, and the values to be signaled are also index values that are serialized so that the number of replications can also be conveyed at the same time. Consequently, more appropriate and flexible conveyance of the MCS in accordance with the transmission mode becomes possible.

### Modification 4

The first embodiment and the like described earlier propose a mechanism whereby, for example, in a case of conveying via the preamble that one of the sub streams has a rate one or two steps lower, the MCS index one or two steps lower in rate is conveyed as the rate that is one or two steps lower.

In other words, it can be said that the embodiments described above and the like give an example of a way of conveying an MCS set focused on the ability of the technology referred to as UEQM to customize both the modulation scheme and the coding rate for each stream. However, the configuration is not limited to the above. To simplify decoding processing for multiple streams that have been allocated to a specific communication device, another naturally conceivable case is to make the coding rates uniform and allow for customization of only the modulation scheme for each stream. Table 17 will be used to describe rates that are one, two, or three steps lower in the case of adopting a configuration that allows for customization of only the modulation scheme for each stream.

TABLE 17
MCS differences in situation where all streams addressed
to same device share common coding rate

| Coding rate R | M | M-1 | M-2 | M-3 |
|---|---|---|---|---|
| 1/2 | 16-QAM | QPSK | BPSK | BPSK-DCM *1 |
| | QPSK | BPSK | BPSK-DCM *1 | — |
| | BPSK | BPSK-DCM *1 | — | — |
| 2/3 | 256-QAM | 64-QAM | 16-QAM | BPSK |
| | 64-QAM | 16-QAM | BPSK | — |
| | 64-QAM | 16-QAM | — | — |
| 3/4 | 4096-QAM | 1024-QAM | 256-QAM | 64-QAM |
| | 1024-QAM | 256-QAM | 64-QAM | 16-QAM |
| | 256-QAM | 64-QAM | 16-QAM | QPSK |
| | 64-QAM | 16-QAM | QPSK | — |
| | 16-QAM | QPSK | — | — |
| 5/6 | 4096-QAM | 1024-QAM | 256-QAM | 64-QAM |
| | 1024-QAM | 256-QAM | 64-QAM | 16-QAM |
| | 256-QAM | 64-QAM | 16-QAM | — |
| | 64-QAM | 16-QAM | — | — |

In this case, the communication device 100 recognizes the modulation scheme (QAM) indicated by the MCS for SS1 indicated in Table 8 or Table 13 as M that serves as a basis. A configuration may then be adopted such that, in the MCS for SS2 and subsequent streams, M−1 and M−2 listed under the same coding rate R indicated in Table 17 are considered to indicate only the modulation scheme for SS2. In other words, the correspondence table in Table 8 or Table 13 may be reconfigured such that M−1 indicates the rate one step lower with respect to M, and M−2 indicates the rate two steps lower with respect to M. In other words, taking the index value of 5 in Table 8 as an example, MCS6 (coding rate 3/4, 16-QAM) is the basis, and M−1 is QPSK. Note that a rate one step lower can also be defined by similar thinking in the case of applying the above to the indication methods in the third and fourth embodiments. In this case, a rate one step lower may be defined as the MCS which belongs to the same coding rate R subset and which is one step lower in modulation rate than the modulation scheme of the MCS that serves as a basis. Adopting a modification in this way makes it possible to individually customize the modulation scheme for each stream while using a common coding rate for multiple streams. Note that BPSK-DCM denoted by “*1” in the table may also be configured not to be included in the difference. In this case, the third pattern is excluded from the available options in the case of the 1/2 coding rate. In other words, in this case, if the MCS that serves as a basis is BPSK, EQM is always used.

As described above, adopting the approach of any of the embodiments described above makes it possible to provide a signaling approach that achieves both flexible signaling of the MCS and signaling of a different MCS for each SS. Moreover, adopting the approach of any of the embodiments described above makes it possible to enhance the convenience of communication.

### Other Embodiments 1

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### Other Embodiments 2

The disclosure is not limited to the embodiments described above, and various changes and modifications are possible without departing from the spirit and scope of the disclosure. Accordingly, the claims are attached to make public the scope of the disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206938, filed Nov. 28, 2024, and No. 2025-162111, filed Sep. 29, 2025, which are hereby incorporated by reference herein in their entirety.

What is claimed is:

1. A control method for a communication device, the control method comprising:
receiving a wireless frame for multi-user multiple input, multiple output (MU-MIMO) communication that conforms to the Institute of Electrical and Electronics Engineers (IEEE) 802.11 standards series, the wireless frame including a preamble that contains
a Universal Signal field (U-SIG) as a first signal field, and
a second signal field which contains information specifying a number of streams for each communication device participating in the MU-MIMO communication and information specifying a modulation and coding scheme (MCS) to be used for each stream corresponding to the number of streams, wherein the information specifying the MCS indicates that a different MCS is to be used for each of a first stream and a second stream directed at a specific communication device; and
decoding the received wireless frame.

2. The control method according to claim 1, wherein the information specifying the MCS in the second signal field of the received wireless frame includes a quadrature phase-shift keying (QPSK) modulation scheme and the 2/3 coding rate.

3. The control method according to claim 2, wherein the information specifying the MCS is stored, in the received wireless frame, in a 5-bit MCS field and a 1-bit field for identifying whether data communication is performed using unequal modulation (UEQM).

4. The control method according to claim 1, wherein the received wireless frame includes one or more values stored in a PHY Version Identifier field of the U-SIG of the wireless frame.

5. The control method according to claim 3, wherein the method further comprises:
receiving a second wireless frame for MU-MIMO communication, the second wireless frame being of a different type than the wireless frame,
wherein a preamble of the second wireless frame contains a Universal Signal field (U-SIG), and an Extremely High Throughput Signal field (EHT-SIG), and
wherein a value of 0 is stored in a PHY Version Identifier field of the U-SIG of the second wireless frame, and the EHT-SIG of the second wireless frame contains information specifying a number of streams for each communication device participating in the MU-MIMO communication and information specifying a modulation and coding scheme (MCS) to be used for all streams directed to a specific communication device.

6. The control method according to claim 1, wherein the second signal field is an Ultra High Reliability Signal field (UHR-SIG).

7. The control method according to claim 1, wherein receiving further includes receiving, by the communication device functioning as a station, the wireless frame for MU-MIMO communication transmitted by an access point.

8. The control method according to claim 7, wherein the decoding further comprises:
identifying a number of streams of data communication addressed to the communication device and the MCS for each stream from the preamble of the received wireless frame, and decoding data according to the identified number of streams and the identified MCS.

9. A control method for a communication device, the control method comprising:
receiving a wireless frame conforming to the Institute of Electrical and Electronics Engineers (IEEE) 802.11 standards series, the received wireless framing being used in multi-user multiple input, multiple output (MU-MIMO) communication and including a preamble including a Universal Signal field (U-SIG) as a first signal field, and a second signal field including information specifying a number of streams for each communication device participating in the MU-MIMO communication, first information specifying a modulation and coding scheme (MCS) that serves as an unequal modulation (UEQM) basis, 1-bit second information that indicates that UEQM is used, and third information that is to be combined with the first information to indicate a UEQM pattern to be used to specify the MCS for each stream; and
decoding the received wireless frame.

10. The control method for a communication device according to claim 9, wherein the first information, the second information, and the third information are included in a 22-bit user field constituting the second signal field, the 22-bit user field including the first information, the second information, and the third information does not include a subfield for explicitly conveying a coding scheme, and the inclusion of the second information implicitly conveys that the coding scheme is low-density parity check (LDPC).

11. A control method for a communication device, the control method comprising:
executing processing for receiving a wireless frame conforming to the Institute of Electrical and Electronics Engineers (IEEE) 802.11 standards series; and
executing processing for decoding the wireless frame,
wherein, in a case where the received wireless frame includes an ELR frame with 0 specified in an MCS subfield, the processing for decoding includes decoding a data portion by interpreting that the data portion needs to be decoded based on parameters indicating that a binary phase-shift keying (BPSK) modulation scheme and the 1/2 coding rate are to be used when executing the processing for receiving the data portion, and in a case where the received wireless frame includes an ELR frame with 1 specified in the MCS subfield, the processing for decoding includes decoding the data portion by interpreting that the data portion needs to be decoded based on parameters indicating that the quadrature phase-shift keying (QPSK) modulation scheme and the 1/2 coding rate are to be used when executing the processing for receiving the data portion.

12. The control method for a communication device according to claim 11,
wherein, based on 0 being specified in the MCS subfield of the ELR frame, the processing for decoding includes
interpreting that the communication parameters to be used in the processing for receiving a data portion indicate the BPSK modulation scheme and the 1/2 coding rate, and
interpreting that the data portion needs to be decoded by determining that, in the data portion, a same content is replicated in the frequency domain, and
in a case where 0 is specified in the MCS subfield of a Multi-User Physical layer Protocol Data Unit (MU PPDU) of a first type, the processing for decoding includes
interpreting that the communication parameters to be used in the processing for receiving a data portion indicate the BPSK modulation scheme and the 1/2 coding rate, and
based on 0 being specified in the MCS subfield of the MU PPDU of the first type, interpreting that the data portion needs to be decoded by determining that, in the replicated data portion, the same content is replicated in the frequency domain.

13. A communication device comprising:
at least one memory that stores a set of instructions; and
at least one processing circuit that executes the instructions, is caused to perform operations comprising:
executing processing for receiving a wireless frame conforming to the Institute of Electrical and Electronics Engineers (IEEE) 802.11 standards series; and
executing processing for decoding the wireless frame,
wherein, in a case where the received wireless frame includes an ELR frame with 0 specified in an MCS subfield, the processing for decoding includes decoding a data portion by interpreting that the data portion needs to be decoded based on parameters indicating that a binary phase-shift keying (BPSK) modulation scheme and the 1/2 coding rate are to be used when executing the processing for receiving the data portion, and in a case where the received wireless frame includes an ELR frame with 1 specified in the MCS subfield, the processing for decoding includes decoding the data portion by interpreting that the data portion needs to be decoded based on parameters indicating that the quadrature phase-shift keying (QPSK) modulation scheme and the 1/2 coding rate are to be used when executing the processing for receiving the data portion.
